(19) United States
(12) Patent Application Publication
(10) Pub. No.: US 2026/0135593 A1
(43) Pub. Date: May 14, 2026

(54) PHASE CONTROL AND/OR PHASE CALIBRATION FOR A NETWORK-CONTROLLED REPEATER

(71) Applicant: QUALCOMM Incorporated, San Diego, CA (US)

(72) Inventors: Hyojin LEE, San Diego, CA (US); Yu ZHANG, San Diego, CA (US); Peter GAAL, San Diego, CA (US); Zhikun WU, Beijing (CN); Wanshi CHEN, San Diego, CA (US); Yi HUANG, San Diego, CA (US)

(21) Appl. No.: 19/121,354

(22) PCT Filed: Nov. 11, 2022
(86) PCT No.: PCT/CN2022/131295

§ 371 Date: Apr. 15, 2025

(51) Int. Cl. H04B 7/06; H04L 5/00; H04W 8/22; H04W 56/00

(52) U.S. Cl. CPC H04B 7/0617; H04B 7/0626; H04L 5/0051; H04W 8/22; H04W 56/0015

(57) ABSTRACT

Various aspects of the present disclosure generally relate to wireless communication. In some aspects, a network node may receive, from a network-controlled repeater (NCR), an NCR capability report that indicates a support for NCR forward beamforming and a quantity of NCR radio frequency (RF) chains. The network node may facilitate, based at least in part on the NCR capability report, one or more of: a phase control for the quantity of NCR RF chains to support a multiple-input multiple-output (MIMO) operation, or a phase calibration for the NCR. Numerous other aspects are described.

### FIELD OF THE DISCLOSURE

Aspects of the present disclosure generally relate to wireless communication and to techniques and apparatuses for phase control and/or phase calibration for a network-controlled repeater (NCR).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a network node includes a memory and one or more processors, coupled to the memory, configured to: receive, from a network-controlled repeater (NCR), an NCR capability report that indicates a support for NCR forward beamforming and a quantity of NCR radio frequency (RF) chains; and facilitate, based at least in part on the NCR capability report, one or more of: a phase control for the quantity of NCR RF chains to support a multiple-input multiple-output (MIMO) operation, or a phase calibration for the NCR.

In some implementations, an apparatus for wireless communication at an NCR includes a memory and one or more processors, coupled to the memory, configured to: transmit, to a network node, an NCR capability report that indicates a support for NCR forward beamforming and a quantity of NCR RF chains; and facilitate, based at least in part on the NCR capability report, one or more of: a phase control for the quantity of NCR RF chains to support a MIMO operation, or a phase calibration for the NCR.

In some implementations, a method of wireless communication performed by a network node includes receiving, from an NCR, an NCR capability report that indicates a support for NCR forward beamforming and a quantity of NCR RF chains; and facilitating, based at least in part on the NCR capability report, one or more of: a phase control for the quantity of NCR RF chains to support a MIMO operation, or a phase calibration for the NCR.

In some implementations, a method of wireless communication performed by an NCR includes transmitting, to a network node, an NCR capability report that indicates a support for NCR forward beamforming and a quantity of NCR RF chains; and facilitating, based at least in part on the NCR capability report, one or more of: a phase control for the quantity of NCR RF chains to support a MIMO operation, or a phase calibration for the NCR.

In some implementations, a non-transitory computer-readable medium storing a set of instructions for wireless communication includes one or more instructions that, when executed by one or more processors of a network node, cause the network node to: receive, from an NCR, an NCR capability report that indicates a support for NCR forward beamforming and a quantity of NCR RF chains; and facilitate, based at least in part on the NCR capability report, one or more of: a phase control for the quantity of NCR RF chains to support a MIMO operation, or a phase calibration for the NCR.

In some implementations, a non-transitory computer-readable medium storing a set of instructions for wireless communication includes one or more instructions that, when executed by one or more processors of an NCR, cause the NCR to: transmit, to a network node, an NCR capability report that indicates a support for NCR forward beamforming and a quantity of NCR RF chains; and facilitate, based at least in part on the NCR capability report, one or more of: a phase control for the quantity of NCR RF chains to support a MIMO operation, or a phase calibration for the NCR.

In some implementations, an apparatus for wireless communication includes means for receiving, from an NCR, an NCR capability report that indicates a support for NCR forward beamforming and a quantity of NCR RF chains; and means for facilitating, based at least in part on the NCR capability report, one or more of: a phase control for the quantity of NCR RF chains to support a MIMO operation, or a phase calibration for the NCR.

In some implementations, an apparatus for wireless communication includes means for transmitting, to a network node, an apparatus capability reporting that indicates a support for apparatus forward beamforming and a number of apparatus RF chains; and means for facilitating, based at least in part on the apparatus capability reporting, one or more of: a phase control for the number of RF chains of the apparatus to support a MIMO operation, or a phase calibration for the apparatus.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a network-controlled repeater (NCR), in accordance with the present disclosure.

FIG. 5 is a diagram illustrating an example of a multi-chain NCR, in accordance with the present disclosure.

FIGS. 6-13 are diagrams illustrating examples associated with phase control and/or phase calibration for an NCR, in accordance with the present disclosure.

FIGS. 14-15 are diagrams illustrating example processes associated with phase control and/or phase calibration for an NCR, in accordance with the present disclosure.

FIGS. 16-17 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof: Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

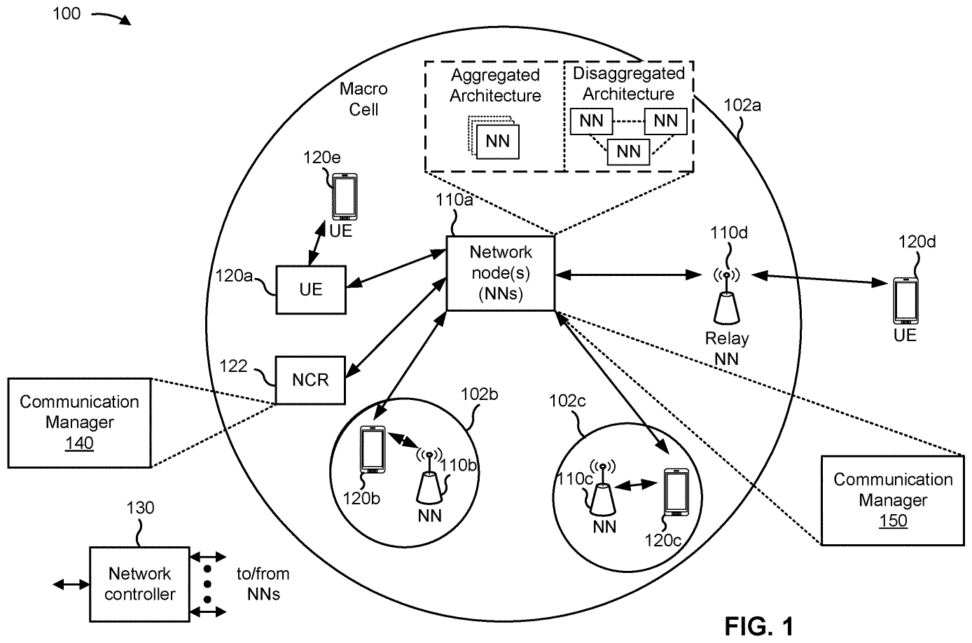

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof: In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof: For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof: In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a network node (e.g., network node 110) may include a communication manager 150. As described in more detail elsewhere herein, the communication manager 150 may receive, from a network-controlled repeater (NCR), an NCR capability report that indicates a support for NCR forward beamforming and a quantity of NCR radio frequency (RF) chains; and facilitate, based at least in part on the NCR capability report, one or more of: a phase control for the quantity of NCR RF chains to support a multiple-input multiple-output (MIMO) operation, or a phase calibration for the NCR. Additionally, or alternatively, the communication manager 150 may perform one or more other operations described herein.

In some aspects, an NCR (e.g., NCR 122) may include a communication manager 140. As described in more detail elsewhere herein, the communication manager 140 may transmit, to a network node, an NCR capability report that indicates a support for NCR forward beamforming and a quantity of NCR RF chains; and facilitate, based at least in part on the NCR capability report, one or more of: a phase control for the quantity of NCR RF chains to support MIMO operation, or a phase calibration for the NCR. Additionally, or alternatively, the communication manager 140 may perform one or more other operations described herein.

As indicated above, FIG. 1 is provided as an example. Other examples may differ from what is described with regard to FIG. 1.

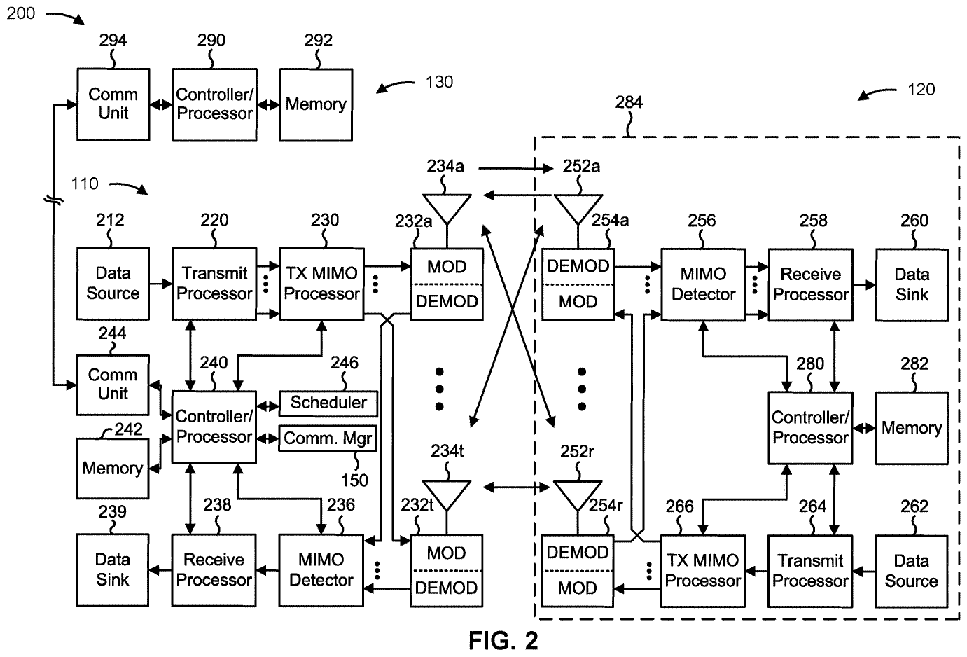

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T>1). The UE 120 may be equipped with a set of antennas 252a through 252r, such as R antennas (R>1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) MIMO processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof: A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

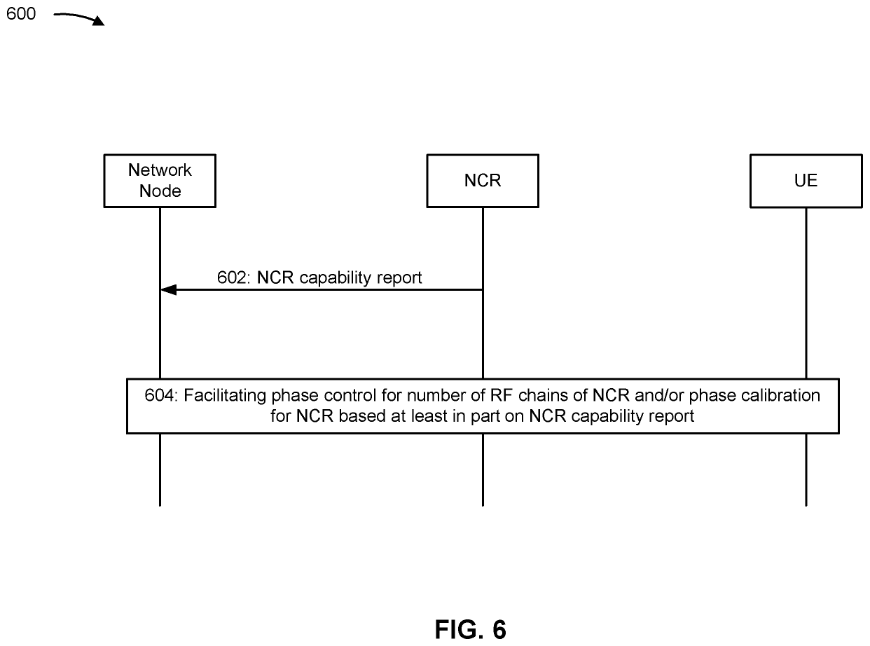

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-17).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-17).

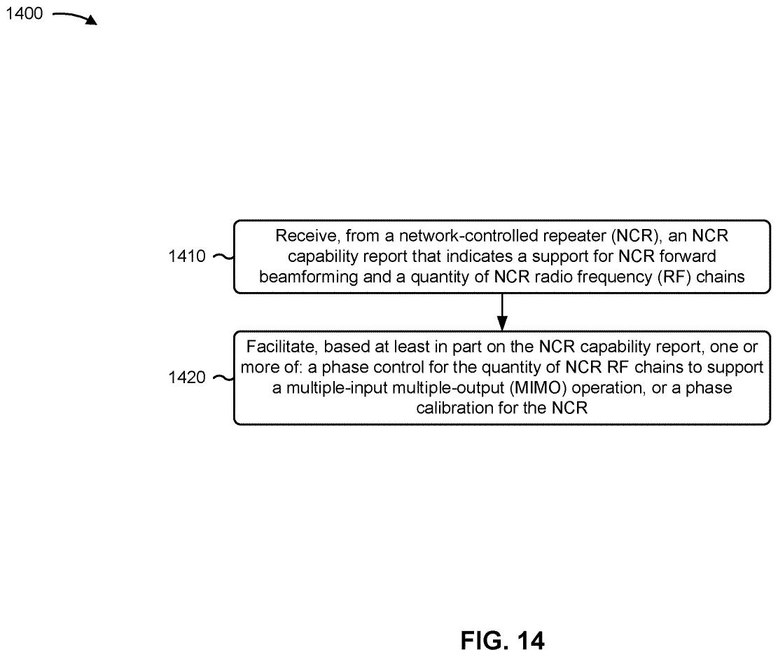

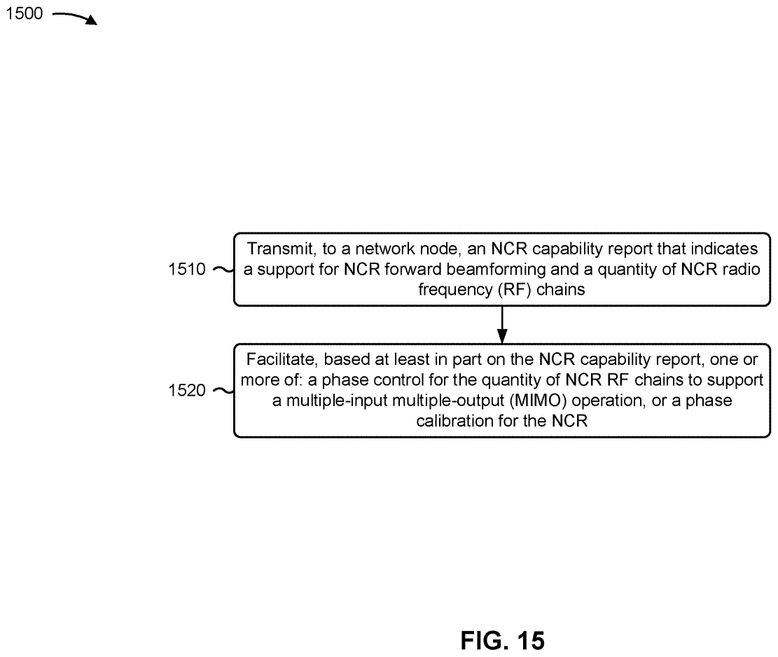

The controller/processor 240 of the network node 110, the controller/processor 280 of the UE 120, and/or any other component(s) of FIG. 2 may perform one or more techniques associated with phase control and/or phase calibration for an NCR, as described in more detail elsewhere herein. In some aspects, the NCR described herein includes one or more components of the network node 110 shown in FIG. 2. In some aspects, the NCR described herein includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, a network node (e.g., network node 110) includes means for receiving, from an NCR, an NCR capability report that indicates a support for NCR forward beamforming and a quantity of NCR RF chains; and/or means for facilitating, based at least in part on the NCR capability report, one or more of: a phase control for the quantity of NCR RF chains to support a MIMO operation, or a phase calibration for the NCR. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an NCR (e.g., NCR 122) includes means for transmitting, to a network node, an NCR capability report that indicates a support for NCR forward beamforming and a quantity of NCR RF chains; and/or means for facilitating, based at least in part on the NCR capability report, one or more of: a phase control for the quantity of NCR RF chains to support a MIMO operation, or a phase calibration for the NCR. In some aspects, the means for the NCR to perform operations described herein may include, for example, one or more of transmit processor 220, TX MIMO processor 230, modem 232, antenna 234, MIMO detector 236, receive processor 238, controller/processor 240, memory 242, or scheduler 246. In some aspects, the means for the NCR to perform operations described herein may include, for example, one or more of antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

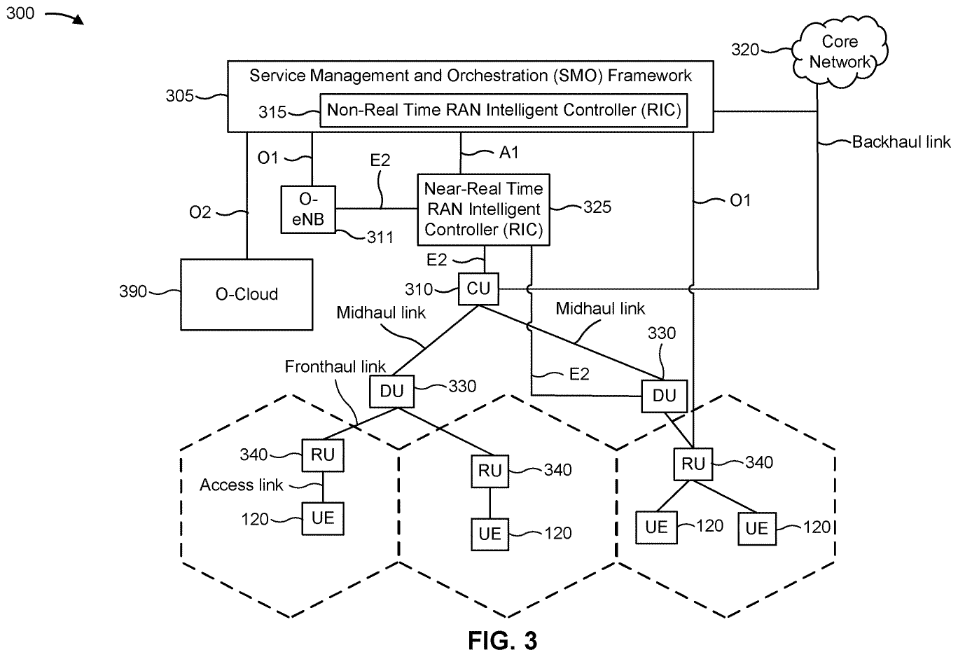

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F 1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof: In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as AI interface policies).

As indicated above, FIG. 3 is provided as an example. Other examples may differ from what is described with regard to FIG. 3.

An RF repeater may provide a cost-effective solution for extending a network coverage. However, an RF repeater may have various limitations. For example, an RF repeater may simply perform an amplify-and-forward operation, without being able to consider various factors that could improve performance. An NCR may be an enhancement over conventional RF repeaters. An NCR may have the capability to receive and process side control information from a network node. The side control information may allow the NCR to perform the amplify-and-forward operation in a more efficient manner. For example, the side control information may enable various benefits, such as a mitigation of unnecessary noise amplification, transmissions and receptions with better spatial directivity, and/or a simplified network integration.

An NCR, such as an NR NCR may be an in-band RF repeater used for extending a network coverage on FR1 and FR2 bands based at least in part on an NCR model. The NCR may be a single hop stationary NCR. The NCR may be transparent to a UE. The NCR may maintain a network-node-repeater link and a repeater-UE link simultaneously. The NCR may support various side control information for controlling an NCR forwarding (NCR-Fwd) of the NCR. Such side control information may include information regarding beamforming, an uplink-downlink ΦUL-DL) time division duplex (TDD), and/or on-off information.

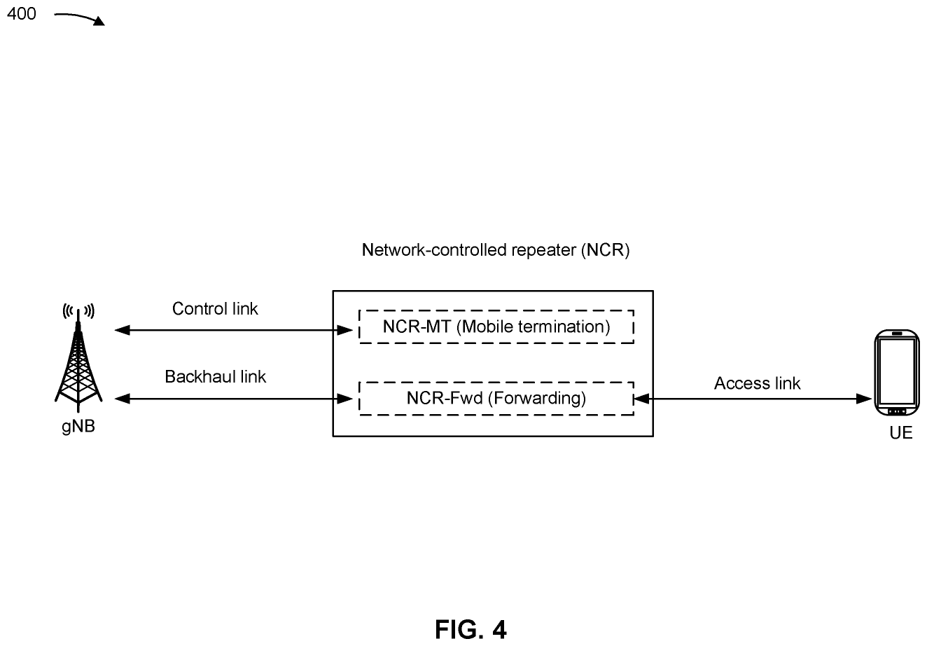

FIG. 4 is a diagram illustrating an example 400 of an NCR, in accordance with the present disclosure.

As shown in FIG. 4, an NCR may include an NCR mobile termination (NCR-MT) and an NCR-Fwd. The NCR-MT may be a functional entity configured to communicate with a network node (e.g., a gNB) via a control link between the NCR-MT and the network node. The control link may be based at least in part on an NR Uu interface. The NCR-MT may communicate with the network node to enable information exchanges (e.g., side control information). A control of the NCR-Fwd may be based at least in part on the side control information. The NCR-Fwd may be a functional entity configured to perform an amplify-and-forwarding of an uplink/downlink RF signal between the network node and a UE via a backhaul link and an access link. The NCR-Fwd may communicate with the network node via the backhaul link between the NCR-Fwd and the network node. The NCR-Fwd may communicate with the UE via the access link between the NCR-Fwd and the UE. A behavior of the NCR-Fwd may be controlled according to receiver side control information from the network node. At least one of the NCR-MT's carrier(s) may be within a set of carriers forwarded by the NCR-Fwd in the same frequency range. The NCR-MT and the NCR-Fwd may operate in the same carrier.

As indicated above, FIG. 4 is provided as an example. Other examples may differ from what is described with regard to FIG. 4.

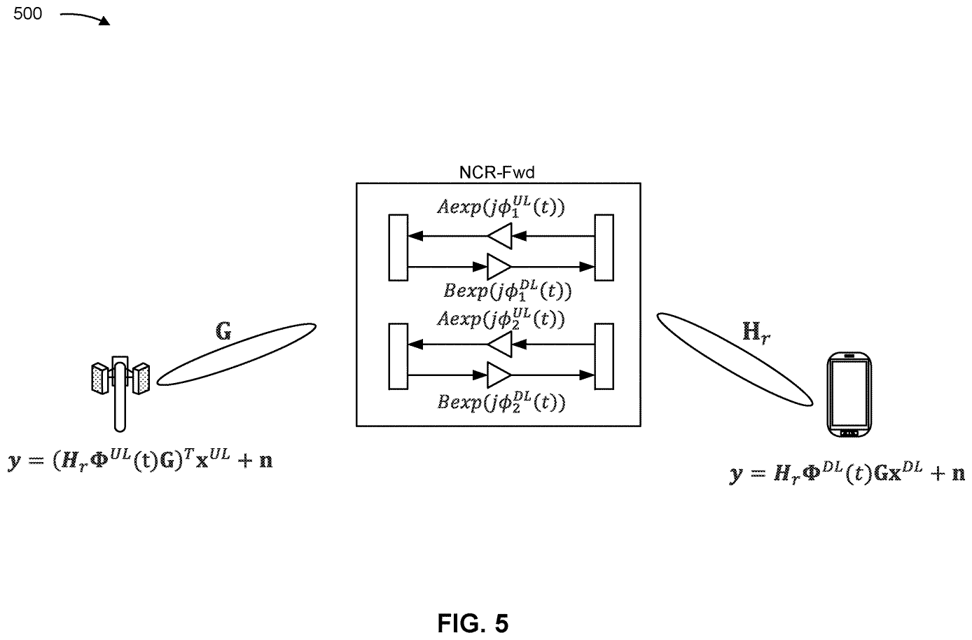

FIG. 5 is a diagram illustrating an example 500 of a multi-chain NCR, in accordance with the present disclosure.

As shown in FIG. 5, a multi-chain NCR may be located in between a network node and a UE. The multi-chain NCR may have multiple RF chains. The multi-chain NCR may perform an amplify-and-forwarding of an uplink/downlink RF signal between the network node and the UE. In this example, the multi-chain NCR may include a first RF chain and a second RF chain. The first RF chain may support an amplify-and-forward of uplink and downlink RF signals. The second RF chain may support an amplify-and-forward of uplink and downlink RF signals. For example, in the first RF chain, an uplink signal may be represented by

$$A exp ( j {ϕ}_{1}^{UL} ( t ) ) ,$$

and a downlink signal may be represented by

$$B exp ( j {ϕ}_{1}^{DL} ( t ) ) ,$$

where A and B indicate amplification gains for the first RF chain,

$${ϕ}_{1}^{UL}$$

indicates an uplink phase for the first RF chain, and

$${ϕ}_{1}^{DL}$$

indicates a downlink phase for the first RF chain. In the second RF chain, an uplink signal may be represented by

$$A exp ( j {ϕ}_{2}^{UL} ( t ) ) ,$$

and a downlink signal may be represented by

$$B exp ( j {ϕ}_{2}^{DL} ( t ) ) ,$$

wherein A and B indicate amplification gains for the second RF chain,

$${ϕ}_{2}^{UL}$$

indicates an uplink phase for the second RF chain, and

$${ϕ}_{2}^{DL}$$

indicates a downlink phase for the second RF chain. Multiple RF chains may be associated with phase differences, between RF chains, with respect to a downlink and an uplink. Different uplink/downlink amplifiers for different RF chains may introduce different phase shifts. Further, the different phases for the different RF chains may be associated with certain time variant properties.

A signal (y) associated with the network node may be defined by y=(HᵣΦ^{UL}(t)G)^{T}×^{UL}+n, where Hᵣ indicates a channel between the multi-chain NCR and the UE, Φ^{UL} indicates an uplink phase, G indicates a channel between the multi-chain NCR and the network node, x^{UL} indicates an uplink signal, and n indicates noise. A signal (y) associated with the UE may be defined by y=HᵣΦ^{DL}(t)Gx^{DL}+n, where Hᵣ indicates the channel between the multi-chain NCR and the UE, Φ^{DL} indicates a downlink phase, G indicates the channel between the multi-chain NCR and the network node, x^{DL} indicates an uplink signal, and n indicates noise.

As indicated above, FIG. 5 is provided as an example. Other examples may differ from what is described with regard to FIG. 5.

Phase coherency may be needed in a multi-chain NCR for FR1. Various phase-coherency requirements may be needed for a frequency division duplex (FDD) or TDD MIMO operation. For a MIMO precoding adaptation, a first phase-coherency requirement may be that Φ^{UL}(t₁)≈αΦ^{UL}(t₂), where Φ^{UL} indicates an uplink phase, t₁ indicates the time when a sound reference signal (SRS) is transmitted from a UE, a indicates a scalar complex value, and t₂ indicates the time when a physical uplink shared channel (PUSCH) is transmitted from the UE. In other words, phase consistency should exist between the SRS transmission at t₁ and the PUSCH transmission at t₂. For the MIMO precoding adaptation, a second phase-coherency requirement may be that Φ^{DL}(t)≈βΦ^{DL}(t₂), where Φ^{DL} indicates a downlink phase, t₁ indicates the time when a channel state information reference signal (CSI-RS) is transmitted from a network node, β indicates a scalar complex value, and t₂ indicates the time when a physical downlink shared channel (PDSCH) is transmitted from the network node. In other words, phase consistency should exist between the CSI-RS transmission at t₁ and the PDSCH transmission at t₂. For an uplink/downlink reciprocity, a third phase-coherency requirement may be that Φ^{UL}(t₁)≈γΦ^{DL}(t₂), where t₁ indicates the time when SRS is received in the network node, γ indicates a scalar complex value, and t₂ indicates the time when the PDSCH is transmitted from the network node.

A phase associated with each NCR chain may be different. For example, a first downlink phase associated with a first RF chain of the multi-chain NCR may be different than a second downlink phase associated with a second RF chain of the multi-chain NCR. A first uplink phase associated with the first RF chain of the multi-chain NCR may be different than a second uplink phase associated with the second RF chain of the multi-chain NCR. When a phase difference does not meet a phase-coherency requirement for FDD/TDD MIMO operation, an FDD/TDD MIMO operation may not be supported. Further, when a phase jump occurs, a resulting phase difference may not meet the phase-coherency requirement for FDD/TDD MIMO operation.

In various aspects of techniques and apparatuses described herein, a network node may receive, from an NCR, an NCR capability report that indicates a support for NCR forward beamforming and a quantity of NCR RF chains. The network node, the NCR, and/or a UE may facilitate, based at least in part on the NCR capability report, a phase control for the quantity of NCR RF chains to support a MIMO operation, and/or a phase calibration for the NCR. In some aspects, in order to resolve a phase difference which does not meet a phase-coherency requirement for FDD/TDD MIMO operation, a mechanism may be defined to control the phase of each NCR RF chain, such that the NCR may be able to support the FDD/TDD MIMO operation. Further, in order to resolve a phase jump that causes the phase difference to not meet the phase-coherency requirement for FDD/TDD MIMO operation, a mechanism may be defined to support the phase calibration, which may be applied after an occurrence of the phase jump. By controlling the phase and/or calibrating the phase, a performance of the network node, the NCR, and/or the UE may be improved.

FIG. 6 is a diagram illustrating an example 600 associated with phase control and/or phase calibration for an NCR, in accordance with the present disclosure. As shown in FIG. 6, example 600 includes communication between a network node (e.g., network node 110), an NCR (e.g., NCR 122), and a UE (e.g., UE 120). In some aspects, the network node, the NCR, and the UE may be included in a wireless network, such as wireless network 100.

As shown by reference number 602, the network node may receive, from the NCR, an NCR capability report. The NCR capability report may indicate a support for NCR forward beamforming, a quantity of NCR RF chains, whether an uplink-downlink reciprocity is supported, a codebook size, and/or a phase shifting alphabet. In some aspects, the network node may transmit, to the NCR, a network node configuration. The network node configuration may indicate a semi-static per-chain on-off indication for a CSI-RS or SRS transmission, a semi-static code-point indication for codebook-based phase control, a dynamic code-point indication for codebook-based phase control, and/or dynamic per-panel phase values for chain-wise phase control.

As shown by reference number 604, the network node, the NCR, and/or the UE may facilitate, based at least in part on the NCR capability report, a phase control for the quantity of NCR RF chains to support a MIMO operation, and/or a phase calibration for the NCR. The phase control for the quantity of NCR RF chains and/or the phase calibration for the NCR may be based at least in part on the network node configuration. The phase control may involve controlling the phase associated with each RF chain of the NCR, such that a phase coherency or phase consistency exists between different RF chains of the NCR. The phase coherency may be needed because phase coherency requirements may be needed for an FDD/TDD MIMO operation. The phase calibration may involve calibrating a phase associated with one or more RF chains of the NCR, such that signals associated with the one or more RF chains of the NCR may be associated with the same phase (or phases that are within a defined threshold from each other). The phase may need to be calibrated in order to satisfy the phase coherency requirements. The phase may need to be calibrated when a certain phase jump occurs (e.g., a phase changes drastically in a relatively short period of time), which may be due to RF state changes such as downlink-uplink switching, off-on operations, or forward gain control. The phase calibration may be based at least in part on signal measurements, such as phase calibration reference signal measurements.

In some aspects, to facilitate the phase control, the network node may receive, from the NCR, an indication of a codebook size for a controllable phase. The network node may perform a synchronization signal block (SSB) sweeping based at least in part on the indication of the codebook size for the controllable phase. A best controllable phase value in relation to a plurality of controllable phase values may be based at least in part on the SSB sweeping. The network node may transmit, to the UE and via the NCR, a CSI-RS based at least in part on the NCR setting the best controllable phase value. The NCR may relay the CSI-RS from the network node to the UE. The network node may receive, from the UE and based at least in part on the CSI-RS, a composite channel measurement, a rank indicator (RI), a precoding matrix indicator (PMI), and/or a CQI. The NCR may relay the composite channel measurement, the RI, the PMI, and/or the CQI from the UE to the network node.

In some aspects, to facilitate the phase control, the network node may perform, with the UE, an initial access based at least in part on a codebook-based SSB sweeping. The network node may transmit, to the UE and via the NCR, a plurality of time division multiplexed CSI-RS resources in accordance with an NCR RF chain on-off configuration. The NCR may relay the plurality of time division multiplexed CSI-RS resources from the network node to the UE. Each CSI-RS resource may be transmitted with one NCR RF chain of the quantity of NCR RF chains turned on and other NCR RF chains of the quantity of NCR RF chains turned off. The network node may receive, from the UE and based at least in part on the plurality of time division multiplexed CSI-RS resources transmitted in accordance with the NCR RF chain on-off configuration, an indication of best controllable phase values, an RI, a PMI, and/or a CQI. The NCR may relay the best controllable phase values, the RI, the PMI, and/or the CQI from the UE to the network node. The RI, the PMI, and/or the CQI may be based at least in part on a composite channel measurement. The composite channel measurement may be based at least in part on UE channel estimations during NCR RF chain on-off times.

In some aspects, to facilitate the phase control, the network node may receive, from a UE and via the NCR, a plurality of time division multiplexed SRS resources in accordance with an NCR RF chain on-off configuration. The NCR may relay the plurality of time division multiplexed SRS resources from the UE to the network node. Each SRS resource may be received with one NCR RF chain of the quantity of NCR RF chains turned on and other NCR RF chains of the quantity of NCR RF chains turned off. The network node may determine, based at least in part on the plurality of time division multiplexed SRS resources received in accordance with the NCR RF chain on-off configuration, best controllable phase values and a precoding matrix. The precoding matrix may be based at least in part on a composite channel measurement. The composite channel measurement may be based at least in part on network node channel estimations during NCR RF chain on-off times.

In some aspects, to facilitate the phase calibration, the network node may receive, from the NCR, an indication of a minimum time duration for phase calibration. The network node may transmit, to the NCR, a configuration of one or more gap periods for phase calibration. The one or more gap periods may be associated with a downlink-uplink switching, an off-on transition, or a gain control. One or more signals may not be forwarded by the NCR during the one or more gap periods for phase calibration. The network node may trigger a phase calibration duration based at least in part on a phase coherency tracking, or a request for a gap period for phase calibration received from the NCR. The requested gap period may indicate a gap period index. The phase calibration at the NCR may be based at least in part on an internal calibration signal at the NCR.

In some aspects, to facilitate the phase calibration, the network node may receive, from the NCR, an indication of a minimum time duration for phase calibration. The network node may transmit, to the NCR, a configuration associated with a phase calibration reference signal. The configuration may indicate a timing for the phase calibration reference signal and additional resource and sequence information associated with the phase calibration reference signal. The network node may transmit, to the NCR, a configuration of one or more gap periods for phase calibration. One or more signals may not be forwarded by the NCR during the one or more gap periods for phase calibration. The network node may trigger the phase calibration reference signal and a phase calibration duration based at least in part on a phase coherency tracking, or a request for the phase calibration reference signal for phase calibration received from the NCR. The network node may transmit, to the NCR, the phase calibration reference signal based at least in part on the trigger. The phase calibration at the NCR may be based at least in part on measurements of the phase calibration reference signal.

In some aspects, to facilitate the phase calibration, the network node may receive, from the NCR, an indication of a minimum time duration for phase calibration. The network node may transmit, to the NCR, a configuration associated with a phase calibration reference signal. The configuration may indicate a timing for the phase calibration reference signal and additional resource and sequence information associated with the phase calibration reference signal. The network node may transmit, to the NCR, a configuration of one or more gap periods for phase calibration. One or more signals may not be forwarded by the NCR during the one or more gap periods for phase calibration. The network node may trigger the phase calibration reference signal and a phase calibration duration based at least in part on a phase coherency tracking, or a request for the phase calibration reference signal for phase calibration received from the NCR. The phase calibration reference signal may be triggered to be received from the UE. The phase calibration at the NCR may be based at least in part on measurements of the phase calibration reference signal received from the UE.

In some aspects, to facilitate the phase calibration, the network node may receive, from the NCR, an indication of the quantity of NCR RF chains and a minimum time duration for phase calibration. The network node may transmit, to the NCR, a configuration associated with a phase calibration reference signal. The configuration may indicate a timing for the phase calibration reference signal, a number of repetitions corresponding to the quantity of NCR RF chains, and additional resource and sequence information associated with the phase calibration reference signal. The network node may transmit, to the NCR, a configuration of one or more gap periods for phase calibration. One or more signals may not be forwarded by the NCR during the one or more gap periods for phase calibration. The network node may trigger the phase calibration reference signal and a phase calibration duration based at least in part on a phase coherency tracking, or a request for the phase calibration reference signal for phase calibration received from the NCR. The network node may transmit, to the UE and via the NCR, the phase calibration reference signal in accordance with an NCR RF chain on-off configuration. The NCR may relay, from the network node to the UE, the phase calibration reference signal. Each repetition of the phase calibration reference signal may be transmitted with one NCR RF chain of the quantity of NCR RF chains turned on and other NCR RF chains of the quantity of NCR RF chains turned off. The network node may receive, from the UE, a report indicating phase change measurements associated with the phase calibration reference signal. The NCR may relay, from the UE to the network node, the report indicating the phase change measurements. The report may indicate the phase change measurements for different repetitions of the phase calibration reference signal. The network node may transmit, to the NCR and based at least in part on the report, an indication for phase values to be calibrated at the NCR. The phase calibration may be implemented at the NCR based at least in part on the indication received from the NCR.

As indicated above, FIG. 6 is provided as an example. Other examples may differ from what is described with regard to FIG. 6.

In some aspects, phase control procedures for a phase-coherent NCR may be defined. The phase control procedures may include a first procedure, a second procedure, and a third procedure.

In some aspects, the first procedure may be associated with an FDD downlink, phase coherent, and UE-transparent approach. In the first procedure, a phase coherency may hold. For example, uncontrollable phase values (φ₁, . . . , φ_{M}) may be constant. An uncontrollable phase may be represented by Φ=diag(e^{jφ}^{₁}, . . . , e^{jφ}^{_{M}}), where M indicates a number of RF chains in the NCR. Each RF chain may be equipped with a phase shifter to control per-panel phase-shift value (θ₁, . . . , θ_{M}). Each RF chain may provide the same forwarding gain A. An NCR may have a codebook {Θ₁, . . . , Θ_{L}} to control controllable phase values. In other words, {Θ₁, . . . , Θ_{L}} may refer to a codebook for NCR phase control.

In some aspects, in the first procedure, which may be based at least in part on a codebook-based phase control, the NCR may report, to a network node, a capability of codebook size (L) for a controllable phase (or controllable phase part). The controllable phase may be represented by Θᵢ=diag(e^{jθ}^{_{i,1}}, . . . , e^{jθ}^{_{i,M}}). The network node may perform an SSB sweeping, which may be based at least in part on the capability of codebook size reported by the NCR. The network node may determine a best controllable phase value (Θ_{i*}) based at least in part on the SSB sweeping. A further phase refinement may be performed with a CSI-RS based measurement reporting. The network node may transmit a CSI-RS after setting Θ_{i*} in an NCR-Fwd of the NCR. A UE may measure a composite channel Hᵣ(AΦ)Θᵢ*G, which may be based at least in part on the CSI-RS, and then the UE may report an RI, a PMI, and/or a CQI.

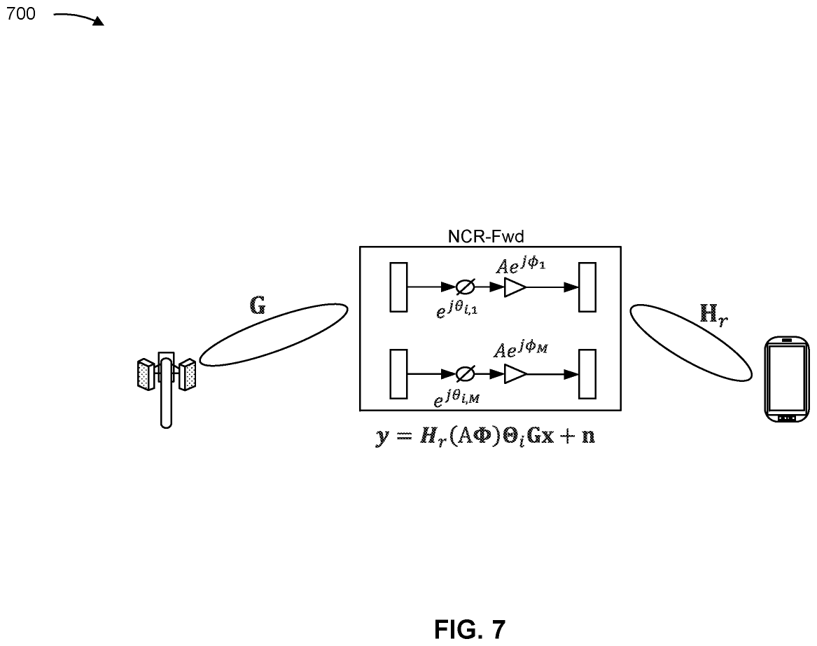

FIG. 7 is a diagram illustrating an example 700 associated with phase control and/or phase calibration for an NCR, in accordance with the present disclosure.

As shown in FIG. 7, an NCR may be in between a network node and a UE. The NCR may include an NCR-Fwd, which may have multiple RF chains. The NCR may include a phase shift controller for each RF chain. Each gain may provide the same forwarding gain A. The NCR may have a codebook {Θ₁, . . . , ΘL} to control controllable phase values. A received downlink signal at the UE may be represented by y=Hᵣ(AΦ)ΘᵢGx+n, where Φ indicates an uncontrollable phase, Φᵢ indicates a controllable phase, and x indicates a transmitted signal.

As indicated above, FIG. 7 is provided as an example. Other examples may differ from what is described with regard to FIG. 7.

In some aspects, a second procedure may be associated with an FDD downlink, phase coherent, and UE-assisted approach. In the second procedure, a phase coherency may hold. For example, uncontrollable phase values (φ₁, . . . , φ_{M}) may be constant. An uncontrollable phase may be represented by Φ=diag(e^{jφ}^{₁}, . . . , e^{jφ}^{_{M}}), where M indicates a number of RF chains in the NCR. Each RF chain may be equipped with a phase shifter to control per-panel phase-shift value (θ₁, . . . , θ_{M}). Each RF chain may provide the same forwarding gain A.

In some aspects, in the second procedure, an initial access may be based at least in part on a code-book based SSB sweeping. For example, as part of the initial access, an NCR may report, to a network node, a capability of codebook size for a controllable phase (or controllable phase part). As part of the initial access, the network node may perform an SSB sweeping, which may be based at least in part on the capability of codebook size reported by the NCR. The network node may transmit, to a UE and via the NCR, M time division multiplexed CSI-RS resources, where the NCR may apply an NCR RF chain on-off scheme or an orthogonal cover code (OCC) watermarking.

For example, when M is four, the network node may transmit a first CSI-RS resource with a first RF chain of the NCR turned on, and a second, third, and fourth RF chain of the NCR turned off. A UE may measure an estimated channel, which may be represented by Ae^{jφ}^{₁} h_{r,1}g⁽¹⁾. The network node may transmit a second CSI-RS resource with the second RF chain of the NCR turned on, and the first, third, and fourth RF chain of the NCR turned off. The UE may measure an estimated channel, which may be represented by Ae^{jφ}^{₂} h_{r,2}g⁽²⁾. The network node may transmit a third CSI-RS resource with the third RF chain of the NCR turned on, and the first, second, and fourth RF chain of the NCR turned off. The UE may measure an estimated channel, which may be represented by Ae^{jφ}^{₃} h_{r,3}g⁽³⁾. The network node may transmit a fourth CSI-RS resource with the fourth RF chain of the NCR turned on, and the first, second, and third RF chain of the NCR turned off. A UE may measure an estimated channel, which may be represented by Ae^{jφ}^{₄} h_{r,4}g⁽⁴⁾. Further,

$$G = [ \begin{matrix}{g}^{( 1 )} \\ ⋮ \\ {g}^{( M )}\end{matrix} ] and {H}_{r} = [ {h}_{r , 1} ... {h}_{r , M} ] .$$

Further, h_{r,1}, h_{r,2}, h_{r,3}, and h_{r,4} may refer to columns of the Hᵣ matrix, and g⁽¹⁾, g⁽²⁾, g⁽³⁾, and g⁽⁴⁾ may refer to rows of the G matrix. The UE may calculate and/or report best controllable phase values (θ₁, . . . , θ_{M}), and an RI, PMI, and/or CQI, while considering a composite channel. The UE may calculate the composite channel in accordance with

$${H}_{r} ( A Φ ) Θ G = {\sum }_{m = 1}^{M} {e}^{j {θ}_{m}} ( {Ae}^{j {ϕ}_{m}} {h}_{r , m} {g}^{( m )} ) .$$

A downlink channel may be represented by with Hᵣ(AΦ)ΘG. In other words, based at least in part on the composite channel, the UE may calculate the best controllable phase values. The UE may report the best controllable phase values to the network node.

In some aspects, the network node may derive (θ₁, . . . , θ_{M}) based at least in part on M Nₜ-port coherent joint transmission (CJT) feedback after transmitting M Nₜ-port CSI-RS resources with a CJT configuration. To be UE transparent, an M Nₜ-port CJT precoding matrix may have the form of:

$$[ \begin{matrix}W \\ {e}^{j {ϕ}_{1}} W \\ ⋮ \\ {e}^{j {ϕ}_{M - 1}} W\end{matrix} ] ,$$

where W indicates a per-TRP precoder.

In some aspects, the UE may determine G_{c}=[vec(h_{r,1}g⁽¹⁾, . . . , vec(h_{r,M}g^{(M)})], which may be based at least in part on different estimated channels associated with different NCR RF chains being turned on or off. For example, the UE may determine G_{c}=[vec(h_{r,1}g⁽¹⁾), . . . , vec(h_{r,M}g^{(M)})] based at least in part on Ae^{jφ}^{₁} h_{r,1}g⁽¹⁾, Ae^{jφ}^{₂} h_{r,2}g⁽²⁾, Ae^{jφ}^{₃}h_{r,3}g⁽³⁾, and Ae^{jφ4} h_{r,4}g⁽⁴⁾. The UE may calculate a direct channel h_{d}=vec(H_{d}), which may be based at least in part on certain measurements. The UE may calculate

$$R = [ \begin{matrix}{G}_{c}^{H} {G}_{c} & {G}_{c}^{H} {h}_{d} \\ {h}_{d}^{H} {G}_{c} & 0\end{matrix} ] ,$$

which may be based at least in part on determine G_{c}=[vec(h_{r,1}g⁽¹⁾), . . . , vec(h_{r,M}g^{(M)})] and h_{d}=vec(H_{d}). The UE may calculate a best controllable phase value

$$( {θ}_{m}^{*} )$$

in accordance with

$${θ}_{m}^{*} = angle ( conj ( {\sum }_{i \neq m}^{M + 1} {e}^{- j {θ}_{i}} {R}_{[ i , m ]} ) ) ,$$

which may maximize a spectrum efficiency. The UE may calculate and update an optimal phase shift θₘ* in accordance with

$$( {θ}_{m}^{*} ) = angle ( conj ( {\sum }_{i \neq m}^{M + 1} {e}^{- j {θ}_{i}} {R}_{[ i , m ]} ) ) ,$$

which may be based at least in part on an input of

$$R = [ \begin{matrix}{G}_{c}^{H} {G}_{c} & {G}_{c}^{H} {h}_{d} \\ {h}_{d}^{H} {G}_{c} & 0\end{matrix} ] .$$

For example, when M is four, the network node may transmit a first CSI-RS resource with a first RF chain of the NCR turned on, and a second, third, and fourth RF chain of the NCR turned off. A UE may measure an estimated channel, which may be represented by Ae^{jφ}^{₁} h_{r,1}g⁽¹⁾. The network node may transmit a second CSI-RS resource with the second RF chain of the NCR turned on, and the first, third, and fourth RF chain of the NCR turned off. The UE may measure an estimated channel, which may be represented by Ae^{jφ}^{₂} h_{r,2}g⁽²⁾. The network node may transmit a third CSI-RS resource with the third RF chain of the NCR turned on, and the first, second, and fourth RF chain of the NCR turned off. The UE may measure an estimated channel, which may be represented by Ae^{jφ}^{₃} h_{r,3}g⁽³⁾. The network node may transmit a fourth CSI-RS resource with the fourth RF chain of the NCR turned on, and the first, second, and third RF chain of the NCR turned off. A UE may measure an estimated channel, which may be represented by Ae^{jφ}^{₄} h_{r,4}g⁽⁴⁾. Further,

$$G = [ \begin{matrix}{g}^{( 1 )} \\ ⋮ \\ {g}^{( M )}\end{matrix} ] and {H}_{r} = [ {h}_{r , 1} ... {h}_{r , M} ] .$$

Further, h_{r,1}, h_{r,2}, h_{r,3}, and h_{r,4} may refer to columns of the Hᵣ matrix, and g⁽¹⁾, g⁽²⁾, g⁽³⁾, and g⁽⁴⁾ may refer to rows of the G matrix. The UE may calculate and/or report best controllable phase values (θ₁, . . . , θ_{M}), and an RI, PMI, and/or CQI, while considering a composite channel. The UE may calculate the composite channel in accordance with

$${H}_{r} ( A Φ ) Θ G = {\sum }_{m = 1}^{M} {e}^{j {θ}_{m}} ( {Ae}^{j {ϕ}_{m}} {h}_{r , m} {g}^{( m )} ) .$$

A downlink channel may be represented by with Hᵣ(AΦ)ΘG. In other words, based at least in part on the composite channel, the UE may calculate the best controllable phase values. The UE may report the best controllable phase values to the network node.

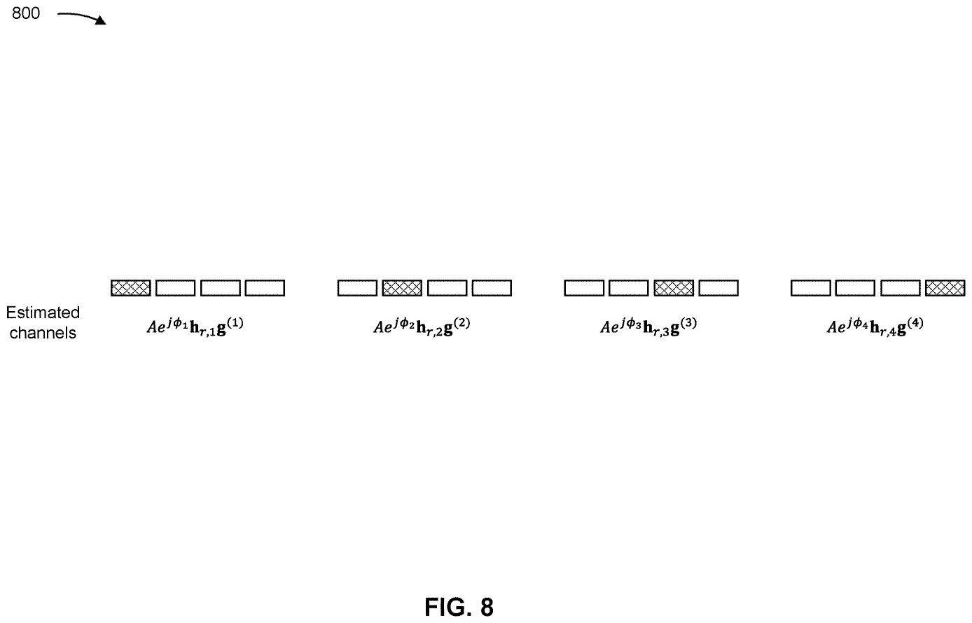

FIG. 8 is a diagram illustrating an example 800 associated with phase control and/or phase calibration for an NCR, in accordance with the present disclosure.

As shown in FIG. 8, M time division multiplexed CSI-RS resources may be transmitted in accordance with an NCR RF chain on-off scheme. When M is four, the network node may transmit a first CSI-RS resource with a first RF chain of the NCR turned on, and a second, third, and fourth RF chain of the NCR turned off. A UE may measure an estimated channel, which may be represented by Ae^{jφ}^{₁} h_{r,1}g⁽¹⁾. The network node may transmit a second CSI-RS resource with the second RF chain of the NCR turned on, and the first, third, and fourth RF chain of the NCR turned off. The UE may measure an estimated channel, which may be represented by Ae^{jφ}^{₂} h_{r,2}g⁽²⁾. The network node may transmit a third CSI-RS resource with the third RF chain of the NCR turned on, and the first, second, and fourth RF chain of the NCR turned off. The UE may measure an estimated channel, which may be represented by Ae^{jφ}^{₃} h_{r,3}g⁽³⁾. The network node may transmit a fourth CSI-RS resource with the fourth RF chain of the NCR turned on, and the first, second, and third RF chain of the NCR turned off. A UE may measure an estimated channel, which may be represented by Ae^{jφ}^{₄} h_{r,4}g⁽⁴⁾. The UE may calculate and/or report best controllable phase values (θ₁, . . . , θ_{M}), and an RI, PMI, and/or CQI, while considering a composite channel. In other words, based at least in part on the composite channel, the UE may calculate the best controllable phase values. The UE may report the best controllable phase values to the network node.

As indicated above, FIG. 8 is provided as an example. Other examples may differ from what is described with regard to FIG. 8.

In some aspects, a third procedure may be associated with an uplink and phase coherent approach. In the third procedure, a phase coherency may hold. For example, uncontrollable phase values (φ₁ . . . , φ_{M}) may be constant. Each RF chain may be equipped with a phase shifter to control per-panel phase-shift value (θ₁, . . . , θ_{M}). Each RF chain may provide the same forwarding gain A.

In some aspects, in the third procedure, a UE may transmit, to a network node and via an NCR, M time division multiplexed SRS resources, where the NCR may apply an NCR RF chain on-off scheme or an OCC watermarking.

For example, when M is four, the UE may transmit a first SRS resource with a first RF chain of the NCR turned on, and a second, third, and fourth RF chain of the NCR turned off. The network node may measure an estimated channel, which may be represented by Ae^{jφ}^{₁} (h_{r,1}g⁽¹⁾)^{T}. The UE may transmit a second SRS resource with the second RF chain of the NCR turned on, and the first, third, and fourth RF chain of the NCR turned off. The network node may measure an estimated channel, which may be represented by Ae^{jφ}^{₂}(h_{r,1}g⁽²⁾)^{T}. The UE may transmit a third SRS resource with the third RF chain of the NCR turned on, and the first, second, and fourth RF chain of the NCR turned off. The network node may measure an estimated channel, which may be represented by Ae^{jφ}^{₃}(h_{r,3}g⁽³⁾)^{T}. The UE may transmit a fourth SRS resource with the fourth RF chain of the NCR turned on, and the first, second, and third RF chain of the NCR turned off. The network node may measure an estimated channel, which may be represented by Ae^{jφ}^{₄} h_{r,4}g⁽⁴⁾. The network node may determine best controllable phase values (θ₁, . . . , θ_{M}) and a downlink precoding matrix, while considering a composite channel. The network node may calculate the composite channel in accordance with

$${( {H}_{r} ( A Φ ) {Θ}_{i} G )}^{T} = {\sum }_{m = 1}^{M} {{e}^{j {θ}_{m}} ( {Ae}^{j {ϕ}_{m}} {h}_{r , m} {g}^{( m )} )}^{T} .$$

In other words, based at least in part on the composite channel, the network node may calculate the best controllable phase values. The UE may report the best controllable phase values to the network node. When an uplink/downlink reciprocity holds, the network node may use estimated sub-channels to determine the controllable phase values and the downlink precoding matrix.

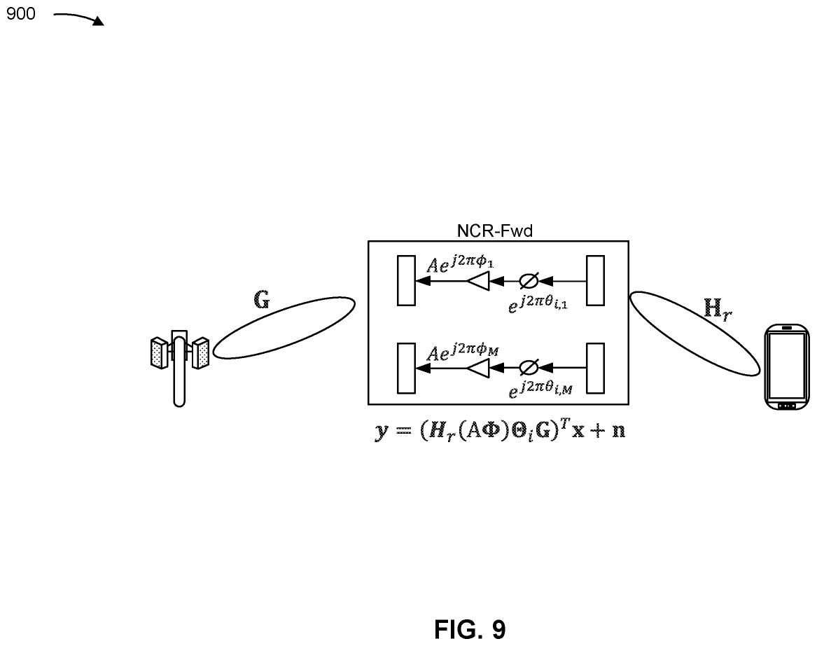

FIG. 9 is a diagram illustrating an example 900 associated with phase control and/or phase calibration for an NCR, in accordance with the present disclosure.

As shown in FIG. 9, an NCR may be in between a network node and a UE. The NCR may include an NCR-Fwd, which may have multiple RF chains. The NCR may include a phase shift controller for each RF chain. Each gain may provide the same forwarding gain A. A received uplink signal at the network node may be represented by y=(Hᵣ(AΦ)ΘᵢG)^{T}x+n, where Φ indicates an uncontrollable phase, Θᵢ indicates a controllable phase, and x indicates a transmitted signal.

As indicated above, FIG. 9 is provided as an example. Other examples may differ from what is described with regard to FIG. 9.

In some aspects, an NCR may be configured for NCR capability report. The NCR may report its capability to a network node and/or a UE. The NCR capability report may indicate whether the NCR supports an NCR-Fwd beamforming or not. When the NCR capability report regarding a number of beams supported for forwarding is equal to one, then NCR-Fwd beamforming may not be supported. The NCR capability report may indicate whether the NCR supports an uplink/downlink reciprocity. The NCR capability report may indicate a number of RF chains. The NCR capability report may indicate a codebook size (in the case of codebook-based phase control). The NCR capability report may indicate a phase shifting alphabet, such as quadrature phase shift keying (QPSK), 8 phase shift keying (8PSK), or 16 phase shift keying (16PSK) (in the case of RF chain-wise phase control).

In some aspects, the network node may transmit a network node configuration or indication to the NCR, and/or to the UE via the NCR. The network node may transmit a semi-static per-chain on-off indication (or OCC indication) for a CSI-RS/SRS transmission. The semi-static per-chain on-off indication may indicate to the NCR which RF chain should be turned on and which RF chains should be turned off with respect to certain CSI-RS/SRS transmissions. The network node may transmit a semi-static code-point indication (in the case of codebook-based phase control), which may be the same as a beam-based operation. The network node may transmit a dynamic code-point indication (in the case of codebook-based phase control), which may be the same as the beam-based operation. The network node may transmit dynamic per-panel phase values (in the case of chain-wise phase control).

In some aspects, the UE may perform a reporting. The UE may transmit a report to the network node. The UE may report best controllable phase values (θ₁, . . . , θ_{M}). The UE may report an RI, a PMI, and/or a CQI, while considering a composite channel.

In some aspects, the NCR capability report, the network node configuration/indication, and/or the UE reporting may be applied to an FR2 multi-panel NCR, for which an inter-panel phase calibration is not performed.

In some aspects, phase calibration schemes for a time-variant NCR phase may be defined. An NCR may perform a phase calibration based at least in part on a first scheme, a second scheme, a third scheme, or a fourth scheme.

In some aspects, a phase jump may occur. Uncontrollable phase values (φ₁(t), . . . , φ_{M}(t)) may be time-variant with the phase-jump due to an occurrence of an event. The phase jump may be caused due to RF state changes such as downlink-uplink switching, off-on operations, or Fwd gain control. An NCR may be equipped with a phase calibrator, which may take a period of time to adjust phase values back to a given state. The NCR may be a multi-chain NCR, and each RF chain may provide the same forwarding gain A.

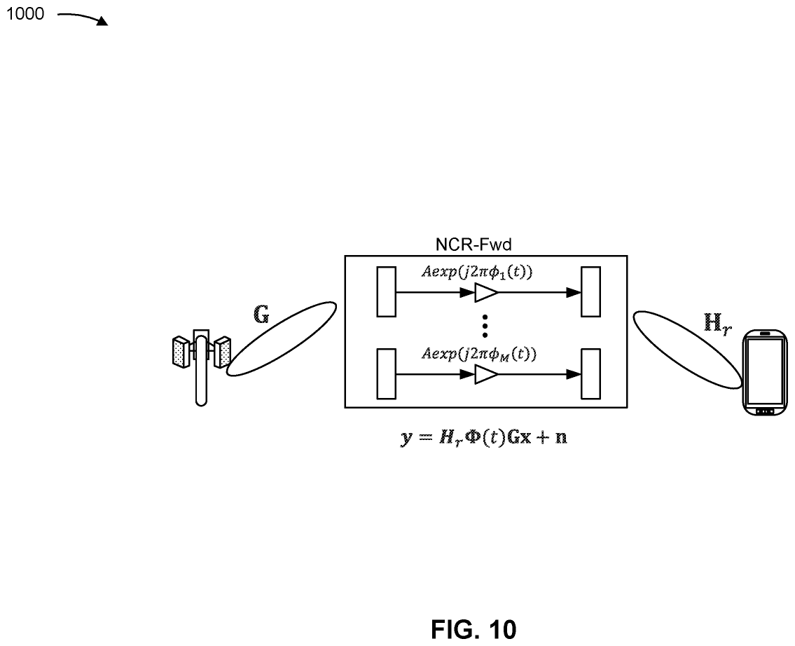

FIG. 10 is a diagram illustrating an example 1000 associated with phase control and/or phase calibration for an NCR, in accordance with the present disclosure.

As shown in FIG. 10, an NCR may be in between a network node and a UE.

The NCR may include an NCR-Fwd, which may have multiple RF chains. A signal associated with a first RF chain of the NCR may be represented by Aexp(jφ₁(t)). A signal associated with an M-th RF chain of the NCR may be represented by Aexp(jφ_{M}(t)). Uncontrollable phase values (φ₁(t), . . . , φ_{M}(t)) may be time-variant with a phase-jump due to an occurrence of an event. Each RF chain may provide the same forwarding gain A. A received signal associated with a network node or a UE may be represented by

$$y = {H}_{r} Φ ( t ) Gx + n , where Φ ( t ) = [ \begin{matrix}{ϕ}_{1} ( t ) & … & 0 \\ ⋮ & ⋱ & ⋮ \\ 0 & … & {ϕ}_{M} ( t )\end{matrix} ]$$

φₘ(t)=U(−θ, θ)+tΔ_{θ}+U(−θ, θ)·δ(t), which may be equal to one when the event occurs.

As indicated above, FIG. 10 is provided as an example. Other examples may differ from what is described with regard to FIG. 10.

In some aspects, for an NCR phase calibration, in a first scheme, an NCR may utilize its own transmit signal and measurement. The NCR may request a network node to guarantee a specific phase calibration gap. The NCR may transmit its own internal transmit signal and perform a phase calibration. The NCR may not be expected to receive (or transmit) any signals within a relevant gap. A second scheme may involve a network-node-assisted and NCR measurement and phase calibration. The network node may transmit a known signal for calibration and an indication of a calibration gap. The network node may transmit the known signal based at least in part on an NCR request. The NCR may measure a phase change, based at least in part on the known signal, and perform the phase calibration. A third scheme may involve a UE-assisted and NCR measurement and phase calibration. The network node may trigger a UE to transmit an uplink known signal. The network node may trigger the UE to transmit the uplink known signal based at least in part on an NCR request. The NCR may measure a phase change, based at least in part on the uplink known signal, and perform the phase calibration. A fourth scheme may involve a network node and UE measurement and an NCR calibration. A phase calibration reference signal may be periodically (or aperiodically) transmitted in an uplink and in a downlink. The UE and the network node may measure phase changes and perform a reporting of the phase changes. For the downlink, the network node may transmit the phase calibration reference signal. For the uplink, the UE may transmit the phase calibration reference signal. The phase calibration reference signal may be transmitted in multiple time division multiplexed resources, where a number of resources may depend on a number of RF chains in the NCR.

In some aspects, the first scheme may involve an NCR internal calibration. The NCR may report, to the network node, a minimum time duration for phase calibration. The network node may configure the NCR with different gap periods (in terms of symbols or slots). The different gap periods may be different state change cases. For example, a first gap may be for after a downlink-uplink switching, a second gap may be for after an off-on transition, and a third gap may be for after a Fwd gain control. The network node may dynamically trigger a phase calibration duration when required. A phase coherency tracking may be performed by the network node, which may involve comparing a CSI-RS reporting with SRS measurements. When an event occurs or is triggered, the NCR may perform the phase calibration. The NCR may not be expected to forward any signals within a configured/triggered gap period. The NCR may transmit an internal calibration signal before components cause a phase-jump, and the NCR may receive a signal after the components, which may allow the NCR to measure a phase difference and perform the phase calibration. The NCR may request, from the network node, a gap period for phase calibration with a gap period index (especially for Fwd gain control). The network node may confirm or trigger the gap period in response. After a network node confirmation, the NCR may operate the phase calibration without forwarding any signals during the relevant gap period.

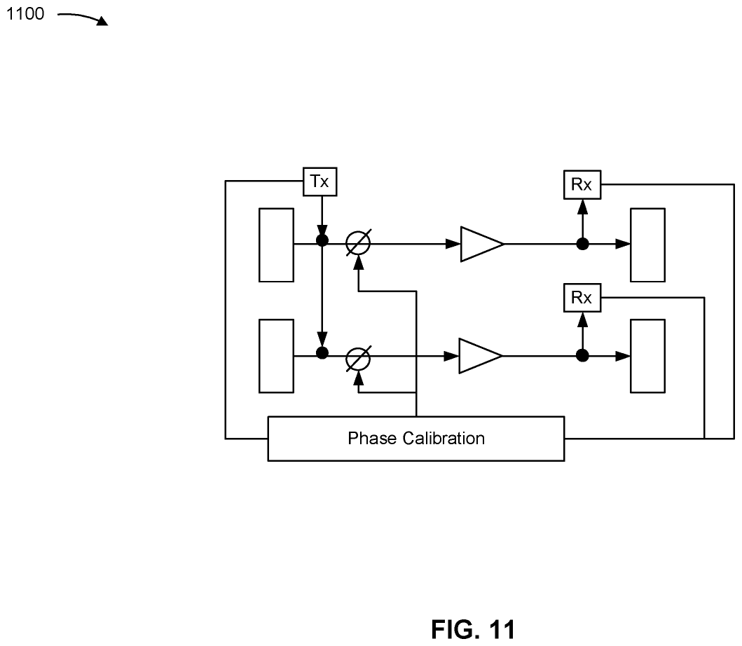

FIG. 11 is a diagram illustrating an example 1100 associated with phase control and/or phase calibration for an NCR, in accordance with the present disclosure.

As shown in FIG. 11, an NCR may transmit an internal calibration signal. The NCR may measure a phase associated with the internal calibration signal, which may occur before the internal calibration signal is affected by components in the NCR causing a phase jump (e.g., an amplifier). The NCR may measure a phase associated with the internal calibration signal after the internal calibration signal is affected by the components in the NCR. As a result, the NCR may determine a phase difference, and the NCR may be able to perform a phase calibration based at least in part on the phase difference.

As indicated above, FIG. 11 is provided as an example. Other examples may differ from what is described with regard to FIG. 11.

In some aspects, a second scheme may involve a network-node-assisted and NCR measurement and phase calibration. An NCR may report, to a network node, a minimum time duration for phase calibration. The network node may configure a phase calibration reference signal with a timing (e.g., a period and an offset) and additional resource and sequence information. The network node may configure a gap period for phase calibration. In some cases, multiple phase calibration reference signals may be configured and different gap periods for different phase calibration reference signals may be configured. The network node may dynamically trigger a phase calibration reference signal and a relevant phase calibration duration when required. A phase coherency tracking may be performed by the network node, which may involve comparing a CSI-RS reporting with SRS measurements. When the phase calibration reference signal is transmitted by the network node, the NCR may perform a phase calibration using phase calibration reference signal measurements. The NCR may not be expected to forward any signals within a configured/triggered gap period. The phase calibration reference signal may be transmitted by the network node for a network-node-assisted phase calibration. The NCR may request, from the network node, the phase calibration reference signal for the phase calibration (especially for Fwd gain control). The network node may confirm the phase calibration reference signal transmission and a relevant gap period in response. After a network node confirmation, the network node may transmit the phase calibration reference signal, and the NCR may operate the phase calibration without transmission or reception of any signals during the relevant gap period.

In some aspects, a third scheme may involve a UE-assisted and NCR measurement and phase calibration. The NCR may report, to the network node, the minimum time duration for phase calibration. The network node may configure the phase calibration reference signal with the timing (e.g., the period and the offset) and additional resource and sequence information. The network node may configure the gap period for phase calibration. In some cases, multiple phase calibration reference signals may be configured and different gap periods for different phase calibration reference signals may be configured. The network node may dynamically trigger the phase calibration reference signal and the relevant phase calibration duration when required. The phase coherency tracking may be performed by the network node, which may involve comparing the CSI-RS reporting with the SRS measurements. When the phase calibration reference signal is transmitted by the UE, the NCR may perform the phase calibration using phase calibration reference signal measurements. The NCR may not be expected to forward any signals within the configured/triggered gap period. The phase calibration reference signal may be transmitted by the UE for a UE-assisted phase calibration. The NCR may request, from the network node, the phase calibration reference signal for the phase calibration (especially for Fwd gain control). The network node may confirm the phase calibration reference signal transmission and the relevant gap period in response. After the network node confirmation, the UE may transmit the phase calibration reference signal, and the NCR may operate the phase calibration without transmission or reception of any signals during the relevant gap period.

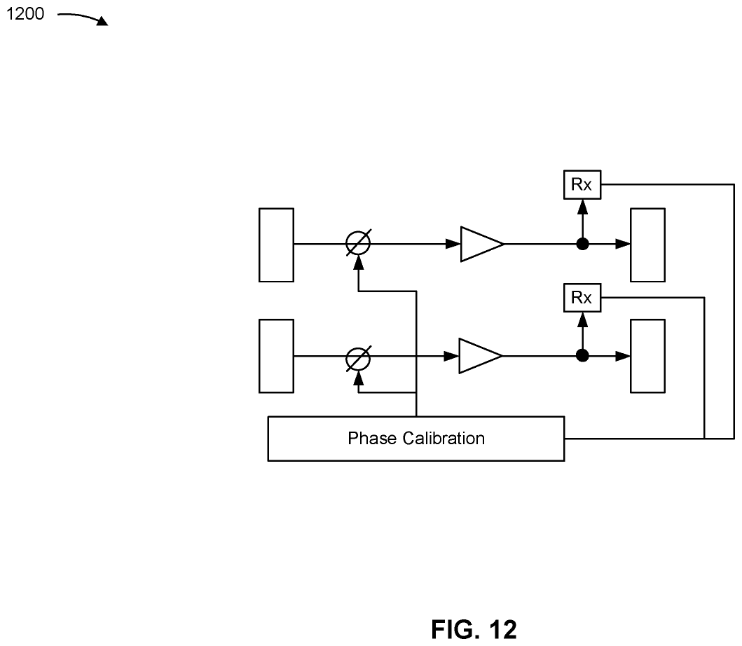

FIG. 12 is a diagram illustrating an example 1200 associated with phase control and/or phase calibration for an NCR, in accordance with the present disclosure.

As shown in FIG. 12, an NCR may receive a phase calibration reference signal from a network node or a UE. The NCR may receive the phase calibration reference signal via multiple RF chains of the NCR. The NCR may perform measurements of the phase calibration signal received via the multiple RF chains of the NCR. Based at least in part on the measurements, the NCR may perform a phase calibration. The NCR may not forward any signals within a configured/triggered gap period.

As indicated above, FIG. 12 is provided as an example. Other examples may differ from what is described with regard to FIG. 12.

In some aspects, an NCR may report, to a network node, a quantity of NCR RF chains and a minimum time duration for phase calibration. The network node may configure a phase calibration reference signal with a timing (e.g., a period and an offset), a number of repetitions (corresponding to a quantity of NCR RF chains), and additional resource and sequence information. The network node may configure a gap period for phase calibration. In some cases, multiple phase calibration reference signals may be configured and different gap periods for different phase calibration reference signals may be configured. The network node may dynamically trigger the phase calibration reference signal and a relevant phase calibration duration when required. A phase coherency tracking may be performed by the network node, which may involve comparing a CSI-RS reporting with SRS measurements. The phase calibration reference signal may be transmitted. For a downlink, the network node may transmit the phase calibration reference signal. For an uplink the UE may transmit the phase calibration reference signal. When the phase calibration reference signal is transmitted, the NCR may perform a chain on-off operation for a phase calibration reference signal measurement at a network node or UE side.

For example, when the NCR has four RF chains, during a first repetition of the phase calibration reference signal, a first RF chain of the NCR may be turned on, and a second, third, and fourth RF chain of the NCR may be turned off. During a second repetition of the phase calibration reference signal, the second RF chain of the NCR may be turned on, and the first, third, and fourth RF chain of the NCR may be turned off. During a third repetition of the phase calibration reference signal, the third RF chain of the NCR may be turned on, and the first, second, and fourth RF chain of the NCR may be turned off. During a fourth repetition of the phase calibration reference signal, the fourth RF chain of the NCR may be turned on, and the first, second, and third RF chain of the NCR may be turned off.

In some aspects, the UE or the network node may measure a phase change, which may be based at least in part on the chain on-off operation for the phase calibration reference signal measurement. The UE may report the NCR phase change values to the network node. The network node may indicate, to the NCR, phase values to be calibrated. During the phase calibration, the NCR may not be expected to forward any signals within a configured gap period. The NCR may request, from the network node, the phase calibration reference signal for the phase calibration (especially for Fwd gain control). The network node may confirm the phase calibration reference signal transmission and the configured gap period in response.

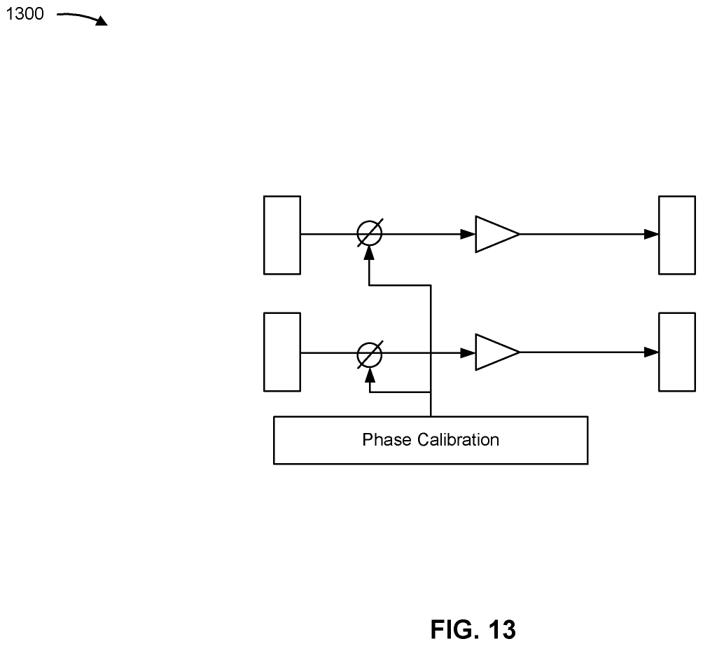

FIG. 13 is a diagram illustrating an example 1300 associated with phase control and/or phase calibration for an NCR, in accordance with the present disclosure.

As shown in FIG. 13, an NCR may receive a phase calibration reference signal from a network node or a UE. The NCR may receive the phase calibration reference signal via multiple RF chains of the NCR. The NCR may perform an RF chain on-off operation for a phase calibration reference signal measurement at the network node or UE side. At a first time, a first RF chain of the NCR may be turned on and a second RF chain of the NCR may be turned off. The first RF chain may forward the phase calibration reference signal to the network node or the UE. At a second time, the first RF chain of the NCR may be turned off and the second RF chain of the NCR may be turned on. The second RF chain may forward the phase calibration reference signal to the network node or the UE. A phase change associated with different phase calibration reference signal received at the network node or the UE may be measured.

As indicated above, FIG. 13 is provided as an example. Other examples may differ from what is described with regard to FIG. 13.

FIG. 14 is a diagram illustrating an example process 1400 performed, for example, by a network node, in accordance with the present disclosure. Example process 1400 is an example where the network node (e.g., network node 110) performs operations associated with phase control and/or phase calibration for an NCR.

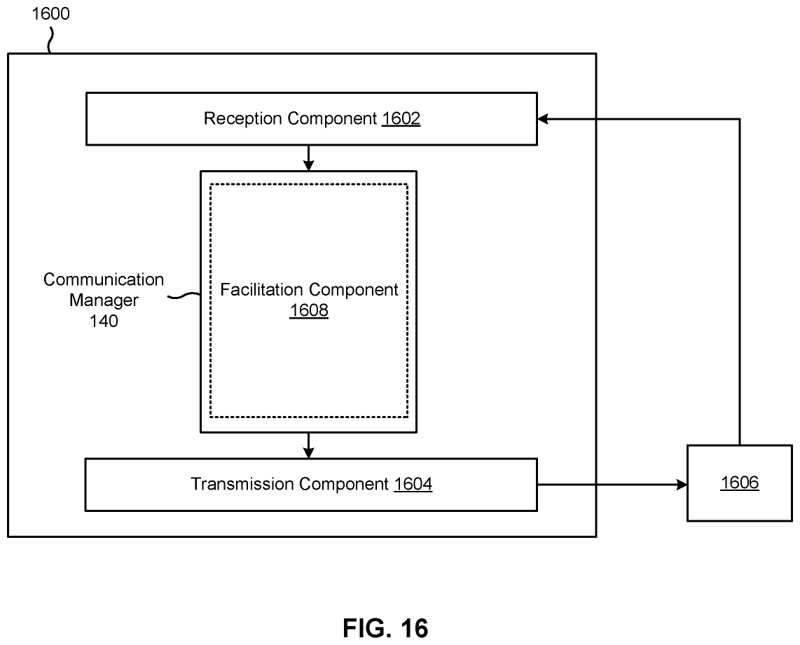

As shown in FIG. 14, in some aspects, process 1400 may include receiving, from an NCR, an NCR capability report that indicates a support for NCR forward beamforming and a quantity of NCR RF chains (block 1410). For example, the network node (e.g., using communication manager 150 and/or reception component 1602, depicted in FIG. 16) may receive, from an NCR, an NCR capability report that indicates a support for NCR forward beamforming and a quantity of NCR RF chains, as described above.

As further shown in FIG. 14, in some aspects, process 1400 may include facilitating, based at least in part on the NCR capability report, one or more of: a phase control for the quantity of NCR RF chains to support a MIMO operation, or a phase calibration for the NCR (block 1420). For example, the network node (e.g., using communication manager 150 and/or facilitation component 1608, depicted in FIG. 16) may facilitate, based at least in part on the NCR capability report, one or more of: a phase control for the quantity of NCR RF chains to support a MIMO operation, or a phase calibration for the NCR, as described above.

Process 1400 may include additional aspects, such as any single aspect or any combination of aspects described below and/or in connection with one or more other processes described elsewhere herein.

In a first aspect, process 1400 includes receiving, from the NCR, an indication of a codebook size for a controllable phase, performing an SSB sweeping based at least in part on the indication of the codebook size for the controllable phase, wherein a best controllable phase value in relation to a plurality of controllable phase values is based at least in part on the SSB sweeping, transmitting, to a UE and via the NCR, a CSI-RS based at least in part on the NCR setting the best controllable phase value, and receiving, from the UE and based at least in part on the CSI-RS, one or more of a composite channel measurement, a rank indicator, a precoding matrix indicator, or a channel quality indicator.

In a second aspect, alone or in combination with the first aspect, process 1400 includes performing, with a UE, an initial access based at least in part on a codebook-based SSB sweeping, transmitting, to the UE and via the NCR, a plurality of time division multiplexed CSI-RS resources in accordance with an NCR RF chain on-off configuration, wherein each CSI-RS resource is transmitted with one NCR RF chain of the quantity of NCR RF chains turned on and other NCR RF chains of the quantity of NCR RF chains turned off, and receiving, from the UE and based at least in part on the plurality of time division multiplexed CSI-RS resources transmitted in accordance with the NCR RF chain on-off configuration, an indication of one or more of best controllable phase values, an RI, a PMI, or a CQI, wherein one or more of the RI, the PMI, or the CQI are based at least in part on a composite channel measurement, and the composite channel measurement is based at least in part on UE channel estimations during NCR RF chain on-off times.

In a third aspect, alone or in combination with one or more of the first and second aspects, process 1400 includes receiving, from a UE and via the NCR, a plurality of time division multiplexed SRS resources in accordance with an NCR RF chain on-off configuration, wherein each SRS resource is received with one NCR RF chain of the quantity of NCR RF chains turned on and other NCR RF chains of the quantity of NCR RF chains turned off, and determining, based at least in part on the plurality of time division multiplexed SRS resources received in accordance with the NCR RF chain on-off configuration, best controllable phase values and a precoding matrix, wherein the precoding matrix is based at least in part on a composite channel measurement, and the composite channel measurement is based at least in part on network node channel estimations during NCR RF chain on-off times.

In a fourth aspect, alone or in combination with one or more of the first through third aspects, the NCR capability report indicates whether an uplink-downlink reciprocity is supported, a codebook size, and a phase shifting alphabet.

In a fifth aspect, alone or in combination with one or more of the first through fourth aspects, process 1400 includes transmitting, to the NCR, a network node configuration that indicates one or more of a semi-static per-chain on-off indication for a CSI-RS or SRS transmission, a semi-static code-point indication for codebook-based phase control, a dynamic code-point indication for codebook-based phase control, or dynamic per-panel phase values for chain-wise phase control, wherein one or more of the phase control for the quantity of NCR RF chains or the phase calibration for the NCR are based at least in part on the network node configuration.

In a sixth aspect, alone or in combination with one or more of the first through fifth aspects, process 1400 includes receiving, from the NCR, an indication of a minimum time duration for phase calibration, transmitting, to the NCR, a configuration of one or more gap periods for phase calibration, wherein the one or more gap periods are associated with a downlink-uplink switching, an off-on transition, or a gain control, and one or more signals are not forwarded by the NCR during the one or more gap periods for phase calibration, and triggering a phase calibration duration based at least in part on a phase coherency tracking or a request for a gap period for phase calibration received from the NCR, wherein the phase calibration at the NCR is based at least in part on an internal calibration signal at the NCR.

In a seventh aspect, alone or in combination with one or more of the first through sixth aspects, process 1400 includes receiving, from the NCR, an indication of a minimum time duration for phase calibration, transmitting, to the NCR, a configuration associated with a phase calibration reference signal, wherein the configuration indicates a timing for the phase calibration reference signal and additional resource and sequence information associated with the phase calibration reference signal, transmitting, to the NCR, a configuration of one or more gap periods for phase calibration, wherein one or more signals are not forwarded by the NCR during the one or more gap periods for phase calibration, triggering the phase calibration reference signal and a phase calibration duration based at least in part on a phase coherency tracking or a request for the phase calibration reference signal for phase calibration received from the NCR, and transmitting, to the NCR, the phase calibration reference signal based at least in part on the triggering, wherein the phase calibration at the NCR is based at least in part on measurements of the phase calibration reference signal.

In an eighth aspect, alone or in combination with one or more of the first through seventh aspects, process 1400 includes receiving, from the NCR, an indication of a minimum time duration for phase calibration, transmitting, to the NCR, a configuration associated with a phase calibration reference signal, wherein the configuration indicates a timing for the phase calibration reference signal and additional resource and sequence information associated with the phase calibration reference signal, transmitting, to the NCR, a configuration of one or more gap periods for phase calibration, wherein one or more signals are not forwarded by the NCR during the one or more gap periods for phase calibration, and triggering the phase calibration reference signal and a phase calibration duration based at least in part on a phase coherency tracking or a request for the phase calibration reference signal for phase calibration received from the NCR, wherein the phase calibration reference signal is triggered to be received from a UE, and the phase calibration at the NCR is based at least in part on measurements of the phase calibration reference signal received from the UE.

In a ninth aspect, alone or in combination with one or more of the first through eighth aspects, process 1400 includes receiving, from the NCR, an indication of the quantity of NCR RF chains and a minimum time duration for phase calibration, transmitting, to the NCR, a configuration associated with a phase calibration reference signal, wherein the configuration indicates a timing for the phase calibration reference signal, a number of repetitions corresponding to the quantity of NCR RF chains, and additional resource and sequence information associated with the phase calibration reference signal, transmitting, to the NCR, a configuration of one or more gap periods for phase calibration, wherein one or more signals are not forwarded by the NCR during the one or more gap periods for phase calibration, triggering the phase calibration reference signal and a phase calibration duration based at least in part on a phase coherency tracking or a request for the phase calibration reference signal for phase calibration received from the NCR, transmitting, to a UE and via the NCR, the phase calibration reference signal in accordance with an NCR RF chain on-off configuration, wherein each repetition of the phase calibration reference signal is transmitted with one NCR RF chain of the quantity of NCR RF chains turned on and other NCR RF chains of the quantity of NCR RF chains turned off, receiving, from the UE, a report indicating phase change measurements associated with the phase calibration reference signal, wherein the report indicates the phase change measurements for different repetitions of the phase calibration reference signal, and transmitting, to the NCR and based at least in part on the report, an indication for phase values to be calibrated at the NCR, wherein the phase calibration is implemented at the NCR based at least in part on the indication received from the NCR.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by an NCR, in accordance with the present disclosure. Example process 1500 is an example where the NCR (e.g., NCR 122) performs operations associated with phase control and/or phase calibration for an NCR.

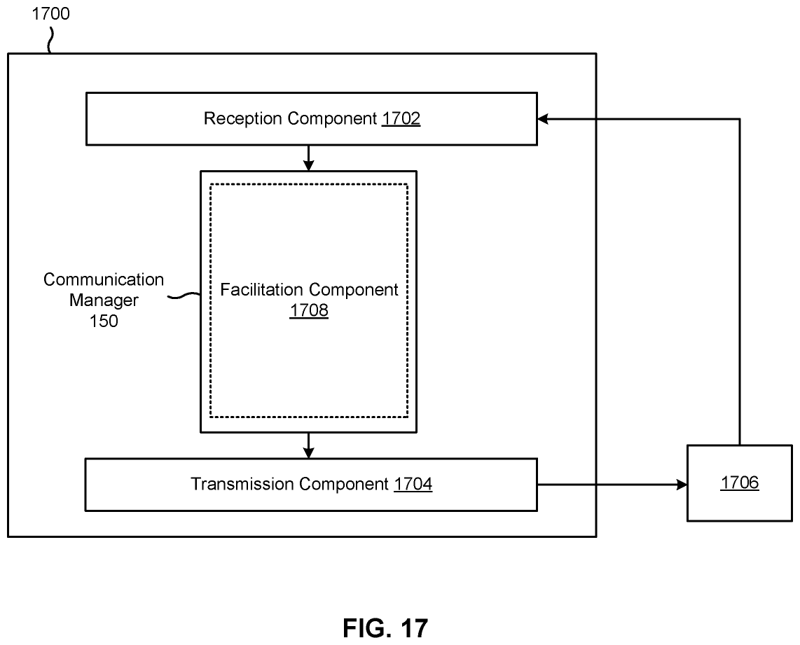

As shown in FIG. 15, in some aspects, process 1500 may include transmitting, to a network node, an NCR capability report that indicates a support for NCR forward beamforming and a quantity of NCR RF chains (block 1510). For example, the NCR (e.g., using communication manager 140 and/or transmission component 1704, depicted in FIG. 17) may transmit, to a network node, an NCR capability report that indicates a support for NCR forward beamforming and a quantity of NCR RF chains, as described above.

As further shown in FIG. 15, in some aspects, process 1500 may include facilitating, based at least in part on the NCR capability report, one or more of: a phase control for the quantity of NCR RF chains to support a MIMO operation, or a phase calibration for the NCR (block 1520). For example, the NCR (e.g., using communication manager 140 and/or facilitation component 1708, depicted in FIG. 17) may facilitate, based at least in part on the NCR capability report, one or more of: a phase control for the quantity of NCR RF chains to support a MIMO operation, or a phase calibration for the NCR, as described above.

Process 1500 may include additional aspects, such as any single aspect or any combination of aspects described below and/or in connection with one or more other processes described elsewhere herein.

In a first aspect, process 1500 includes transmitting, to the network node, an indication of a codebook size for a controllable phase, wherein an SSB sweeping is based at least in part on the indication of the codebook size for the controllable phase, and a best controllable phase value in relation to a plurality of controllable phase values is based at least in part on the SSB sweeping, relaying, from the network node to a UE, a CSI-RS based at least in part on setting the best controllable phase value, and relaying, from the UE to the network node, one or more of a composite channel measurement, an RI, a PMI, or a CQI.

In a second aspect, alone or in combination with the first aspect, process 1500 includes relaying, from the network node to a UE, a plurality of time division multiplexed CSI-RS resources in accordance with an NCR RF chain on-off configuration, wherein each CSI-RS resource is communicated with one NCR RF chain of the quantity of NCR RF chains turned on and other NCR RF chains of the quantity of NCR RF chains turned off, and relaying, from the UE to the network node and based at least in part on the plurality of time division multiplexed CSI-RS resources transmitted in accordance with the NCR RF chain on-off configuration, an indication of one or more of best controllable phase values, an RI, a PMI, or a CQI, wherein one or more of the RI, the PMI, or the CQI are based at least in part on a composite channel measurement, and the composite channel measurement is based at least in part on UE channel estimations during NCR RF chain on-off times.

In a third aspect, alone or in combination with one or more of the first and second aspects, process 1500 includes relaying, from a UE to the network node, a plurality of time division multiplexed SRS resources in accordance with an NCR RF chain on-off configuration, wherein each SRS resource is communicated with one NCR RF chain of the quantity of NCR RF chains turned on and other NCR RF chains of the quantity of NCR RF chains turned off, wherein best controllable phase values and a precoding matrix are based at least in part on the plurality of time division multiplexed SRS resources, wherein the precoding matrix is based at least in part on a composite channel measurement, and the composite channel measurement is based at least in part on network node channel estimations during NCR RF chain on-off times.

In a fourth aspect, alone or in combination with one or more of the first through third aspects, the NCR capability report indicates whether an uplink-downlink reciprocity is supported, a codebook size, and a phase shifting alphabet.

In a fifth aspect, alone or in combination with one or more of the first through fourth aspects, process 1500 includes receiving, from the network node, a network node configuration that indicates one or more of a semi-static per-chain on-off indication for a CSI-RS or SRS transmission, a semi-static code-point indication for codebook-based phase control, a dynamic code-point indication for codebook-based phase control, or dynamic per-panel phase values for chain-wise phase control, wherein one or more of the phase control for the quantity of NCR RF chains or the phase calibration for the NCR are based at least in part on the network node configuration.

In a sixth aspect, alone or in combination with one or more of the first through fifth aspects, process 1500 includes transmitting, to the network node, an indication of a minimum time duration for phase calibration, and receiving, from the network node, a configuration of one or more gap periods for phase calibration, wherein the one or more gap periods are associated with a downlink-uplink switching, an off-on transition, or a gain control, wherein one or more signals are not forwarded by the NCR during the one or more gap periods for phase calibration, wherein a phase calibration duration is triggered based at least in part on a phase coherency tracking or a request for a gap period for phase calibration from the NCR, wherein the phase calibration at the NCR is based at least in part on an internal calibration signal at the NCR.

In a seventh aspect, alone or in combination with one or more of the first through sixth aspects, process 1500 includes transmitting, to the network node, an indication of a minimum time duration for phase calibration, and receiving, from the network node, a configuration associated with a phase calibration reference signal, wherein the configuration indicates a timing for the phase calibration reference signal and additional resource and sequence information associated with the phase calibration reference signal, receiving, from the network node, a configuration of one or more gap periods for phase calibration, wherein one or more signals are not forwarded by the NCR during the one or more gap periods for phase calibration, wherein the phase calibration reference signal and a phase calibration duration are triggered based at least in part on a phase coherency tracking or a request for the phase calibration reference signal for phase calibration from the NCR, and receiving, from the network node, the phase calibration reference signal based at least in part on the phase calibration reference signal and the phase calibration duration being triggered, wherein the phase calibration at the NCR is based at least in part on measurements of the phase calibration reference signal.

In an eighth aspect, alone or in combination with one or more of the first through seventh aspects, process 1500 includes transmitting, to the network node, an indication of a minimum time duration for phase calibration, receiving, from the network node, a configuration associated with a phase calibration reference signal, wherein the configuration indicates a timing for the phase calibration reference signal and additional resource and sequence information associated with the phase calibration reference signal, and receiving, from the network node, a configuration of one or more gap periods for phase calibration, wherein one or more signals are not forwarded by the NCR during the one or more gap periods for phase calibration, wherein the phase calibration reference signal and a phase calibration duration are triggered based at least in part on a phase coherency tracking or a request for the phase calibration reference signal for phase calibration from the NCR, wherein the phase calibration reference signal is triggered to be received from a UE, and the phase calibration at the NCR is based at least in part on measurements of the phase calibration reference signal received from the UE.

In a ninth aspect, alone or in combination with one or more of the first through eighth aspects, process 1500 includes transmitting, to the network node, an indication of the quantity of NCR RF chains and a minimum time duration for phase calibration, receiving, from the network node, a configuration associated with a phase calibration reference signal, wherein the configuration indicates a timing for the phase calibration reference signal, a number of repetitions corresponding to the quantity of NCR RF chains, and additional resource and sequence information associated with the phase calibration reference signal, receiving, from the network node, a configuration of one or more gap periods for phase calibration, wherein one or more signals are not forwarded by the NCR during the one or more gap periods for phase calibration, wherein the phase calibration reference signal and a phase calibration duration are triggered based at least in part on a phase coherency tracking or a request for the phase calibration reference signal for phase calibration from the NCR, relaying, from the network node to a UE, the phase calibration reference signal in accordance with an NCR RF chain on-off configuration, wherein each repetition of the phase calibration reference signal is communicated with one NCR RF chain of the quantity of NCR RF chains turned on and other NCR RF chains of the quantity of NCR RF chains turned off, relaying, from the UE to the network node, a report indicating phase change measurements associated with the phase calibration reference signal, wherein the report indicates the phase change measurements for different repetitions of the phase calibration reference signal, and receiving, from the network node and based at least in part on the report, an indication for phase values to be calibrated at the NCR, wherein the phase calibration is implemented at the NCR based at least in part on the indication received from the NCR.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 150. The communication manager 150 may include a facilitation component 1608, among other examples.

In some aspects, the apparatus 1600 may be configured to perform one or more operations described herein in connection with FIGS. 6-13. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

The reception component 1602 may receive, from an NCR, an NCR capability report that indicates a support for NCR forward beamforming and a quantity of NCR RF chains. The facilitation component 1608 may facilitate, based at least in part on the NCR capability report, one or more of: a phase control for the quantity of NCR RF chains to support a MIMO operation, or a phase calibration for the NCR.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be an NCR, or an NCR may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 140. The communication manager 140 may include a facilitation component 1708, among other examples.

In some aspects, the apparatus 1700 may be configured to perform one or more operations described herein in connection with FIGS. 6-13. Additionally, or alternatively, the apparatus 1700 may be configured to perform one or more processes described herein, such as process 1500 of FIG. 15. In some aspects, the apparatus 1700 and/or one or more components shown in FIG. 17 may include one or more components of the NCR described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the NCR described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the NCR described in connection with FIG. 2. In some aspects, the transmission component 1704 may be co-located with the reception component 1702 in a transceiver.

The transmission component 1704 may transmit, to a network node, an NCR capability report that indicates a support for NCR forward beamforming and a quantity of NCR RF chains. The facilitation component 1708 may facilitate, based at least in part on the NCR capability report, one or more of: a phase control for the quantity of NCR RF chains to support a MIMO operation, or a phase calibration for the NCR.

The number and arrangement of components shown in FIG. 17 are provided as an example. In practice, there may be additional components, fewer components, different components, or differently arranged components than those shown in FIG. 17.

Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a network node, comprising: receiving, from a network-controlled repeater (NCR), an NCR capability report that indicates a support for NCR forward beamforming and a quantity of NCR radio frequency (RF) chains; and facilitating, based at least in part on the NCR capability report, one or more of: a phase control for the quantity of NCR RF chains to support a multiple-input multiple-output (MIMO) operation, or a phase calibration for the NCR.

Aspect 2: The method of Aspect 1, wherein facilitating the phase control further comprises: receiving, from the NCR, an indication of a codebook size for a controllable phase; performing a synchronization signal block (SSB) sweeping based at least in part on the indication of the codebook size for the controllable phase, wherein a best controllable phase value in relation to a plurality of controllable phase values is based at least in part on the SSB sweeping; transmitting, to a user equipment (UE) and via the NCR, a channel state information reference signal (CSI-RS) based at least in part on the NCR setting the best controllable phase value; and receiving, from the UE and based at least in part on the CSI-RS, one or more of: a composite channel measurement, a rank indicator, a precoding matrix indicator, or a channel quality indicator.

Aspect 3: The method of any of Aspects 1-2, wherein facilitating the phase control further comprises: performing, with a user equipment (UE), an initial access based at least in part on a codebook-based synchronization signal block (SSB) sweeping; transmitting, to the UE and via the NCR, a plurality of time division multiplexed channel state information reference signal (CSI-RS) resources in accordance with an NCR RF chain on-off configuration, wherein each CSI-RS resource is transmitted with one NCR RF chain of the quantity of NCR RF chains turned on and other NCR RF chains of the quantity of NCR RF chains turned off; and receiving, from the UE and based at least in part on the plurality of time division multiplexed CSI-RS resources transmitted in accordance with the NCR RF chain on-off configuration, an indication of one or more of: best controllable phase values, a rank indicator (RI), a precoding matrix indicator (PMI), or a channel quality indicator (CQI), wherein one or more of the RI, the PMI, or the CQI are based at least in part on a composite channel measurement, and wherein the composite channel measurement is based at least in part on UE channel estimations during NCR RF chain on-off times.

Aspect 4: The method of any of Aspects 1-3, wherein facilitating the phase control further comprises: receiving, from a user equipment (UE) and via the NCR, a plurality of time division multiplexed sounding reference signal (SRS) resources in accordance with an NCR RF chain on-off configuration, wherein each SRS resource is received with one NCR RF chain of the quantity of NCR RF chains turned on and other NCR RF chains of the quantity of NCR RF chains turned off; and determining, based at least in part on the plurality of time division multiplexed SRS resources received in accordance with the NCR RF chain on-off configuration, best controllable phase values and a precoding matrix, wherein the precoding matrix is based at least in part on a composite channel measurement, and wherein the composite channel measurement is based at least in part on network node channel estimations during NCR RF chain on-off times.

Aspect 5: The method of any of Aspects 1-4, wherein the NCR capability report indicates whether an uplink-downlink reciprocity is supported, a codebook size, and a phase shifting alphabet.

Aspect 6: The method of any of Aspects 1-5, further comprising: transmitting, to the NCR, a network node configuration that indicates one or more of: a semi-static per-chain on-off indication for a channel state information reference signal (CSI-RS) or sounding reference signal (SRS) transmission, a semi-static code-point indication for codebook-based phase control, a dynamic code-point indication for codebook-based phase control, or dynamic per-panel phase values for chain-wise phase control, wherein one or more of the phase control for the quantity of NCR RF chains or the phase calibration for the NCR are based at least in part on the network node configuration.

Aspect 7: The method of any of Aspects 1-6, wherein facilitating the phase calibration further comprises: receiving, from the NCR, an indication of a minimum time duration for phase calibration; transmitting, to the NCR, a configuration of one or more gap periods for phase calibration, wherein the one or more gap periods are associated with a downlink-uplink switching, an off-on transition, or a gain control, wherein one or more signals are not forwarded by the NCR during the one or more gap periods for phase calibration; and triggering a phase calibration duration based at least in part on a phase coherency tracking or a request for a gap period for phase calibration received from the NCR, wherein the phase calibration at the NCR is based at least in part on an internal calibration signal at the NCR.

Aspect 8: The method of any of Aspects 1-7, wherein facilitating the phase calibration further comprises: receiving, from the NCR, an indication of a minimum time duration for phase calibration; transmitting, to the NCR, a configuration associated with a phase calibration reference signal, wherein the configuration indicates a timing for the phase calibration reference signal and additional resource and sequence information associated with the phase calibration reference signal; transmitting, to the NCR, a configuration of one or more gap periods for phase calibration, wherein one or more signals are not forwarded by the NCR during the one or more gap periods for phase calibration; triggering the phase calibration reference signal and a phase calibration duration based at least in part on a phase coherency tracking or a request for the phase calibration reference signal for phase calibration received from the NCR; and transmitting, to the NCR, the phase calibration reference signal based at least in part on the triggering, wherein the phase calibration at the NCR is based at least in part on measurements of the phase calibration reference signal.

Aspect 9: The method of any of Aspects 1-8, wherein facilitating the phase calibration further comprises: receiving, from the NCR, an indication of a minimum time duration for phase calibration; transmitting, to the NCR, a configuration associated with a phase calibration reference signal, wherein the configuration indicates a timing for the phase calibration reference signal and additional resource and sequence information associated with the phase calibration reference signal; transmitting, to the NCR, a configuration of one or more gap periods for phase calibration, wherein one or more signals are not forwarded by the NCR during the one or more gap periods for phase calibration; and triggering the phase calibration reference signal and a phase calibration duration based at least in part on a phase coherency tracking or a request for the phase calibration reference signal for phase calibration received from the NCR, wherein the phase calibration reference signal is triggered to be received from a user equipment (UE), and wherein the phase calibration at the NCR is based at least in part on measurements of the phase calibration reference signal received from the UE.

Aspect 10: The method of any of Aspects 1-9, wherein facilitating the phase calibration further comprises: receiving, from the NCR, an indication of the quantity of NCR RF chains and a minimum time duration for phase calibration; transmitting, to the NCR, a configuration associated with a phase calibration reference signal, wherein the configuration indicates a timing for the phase calibration reference signal, a number of repetitions corresponding to the quantity of NCR RF chains, and additional resource and sequence information associated with the phase calibration reference signal; transmitting, to the NCR, a configuration of one or more gap periods for phase calibration, wherein one or more signals are not forwarded by the NCR during the one or more gap periods for phase calibration; triggering the phase calibration reference signal and a phase calibration duration based at least in part on a phase coherency tracking or a request for the phase calibration reference signal for phase calibration received from the NCR; transmitting, to a user equipment (UE) and via the NCR, the phase calibration reference signal in accordance with an NCR RF chain on-off configuration, wherein each repetition of the phase calibration reference signal is transmitted with one NCR RF chain of the quantity of NCR RF chains turned on and other NCR RF chains of the quantity of NCR RF chains turned off; receiving, from the UE, a report indicating phase change measurements associated with the phase calibration reference signal, wherein the report indicates the phase change measurements for different repetitions of the phase calibration reference signal; and transmitting, to the NCR and based at least in part on the report, an indication for phase values to be calibrated at the NCR, wherein the phase calibration is implemented at the NCR based at least in part on the indication received from the NCR.

Aspect 11: A method of wireless communication performed by a network-controlled repeater (NCR), comprising: transmitting, to a network node, an NCR capability report that indicates a support for NCR forward beamforming and a quantity of NCR radio frequency (RF) chains; and facilitating, based at least in part on the NCR capability report, one or more of: a phase control for the quantity of NCR RF chains to support a multiple-input multiple-output (MIMO) operation, or a phase calibration for the NCR.

Aspect 12: The method of Aspect 11, wherein facilitating the phase control further comprises: transmitting, to the network node, an indication of a codebook size for a controllable phase, wherein a synchronization signal block (SSB) sweeping is based at least in part on the indication of the codebook size for the controllable phase, and wherein a best controllable phase value in relation to a plurality of controllable phase values is based at least in part on the SSB sweeping; relaying, from the network node to a user equipment (UE), a channel state information reference signal (CSI-RS) based at least in part on setting the best controllable phase value; and relaying, from the UE to the network node, one or more of: a composite channel measurement, a rank indicator, a precoding matrix indicator, or a channel quality indicator.

Aspect 13: The method of any of Aspects 11-12, wherein facilitating the phase control further comprises: relaying, from the network node to a user equipment (UE), a plurality of time division multiplexed channel state information reference signal (CSI-RS) resources in accordance with an NCR RF chain on-off configuration, wherein each CSI-RS resource is communicated with one NCR RF chain of the quantity of NCR RF chains turned on and other NCR RF chains of the quantity of NCR RF chains turned off; and relaying, from the UE to the network node and based at least in part on the plurality of time division multiplexed CSI-RS resources transmitted in accordance with the NCR RF chain on-off configuration, an indication of one or more of: best controllable phase values, a rank indicator (RI), a precoding matrix indicator (PMI), or a channel quality indicator (CQI), wherein one or more of the RI, the PMI, or the CQI are based at least in part on a composite channel measurement, and wherein the composite channel measurement is based at least in part on UE channel estimations during NCR RF chain on-off times.

Aspect 14: The method of any of Aspects 11-13, wherein facilitating the phase control further comprises: relaying, from a user equipment (UE) to the network node, a plurality of time division multiplexed sounding reference signal (SRS) resources in accordance with an NCR RF chain on-off configuration, wherein each SRS resource is communicated with one NCR RF chain of the quantity of NCR RF chains turned on and other NCR RF chains of the quantity of NCR RF chains turned off, wherein best controllable phase values and a precoding matrix are based at least in part on the plurality of time division multiplexed SRS resources, wherein the precoding matrix is based at least in part on a composite channel measurement, and wherein the composite channel measurement is based at least in part on network node channel estimations during NCR RF chain on-off times.

Aspect 15: The method of any of Aspects 11-14, wherein the NCR capability report indicates whether an uplink-downlink reciprocity is supported, a codebook size, and a phase shifting alphabet.

Aspect 16: The method of any of Aspects 11-15, further comprising: receiving, from the network node, a network node configuration that indicates one or more of: a semi-static per-chain on-off indication for a channel state information reference signal (CSI-RS) or sounding reference signal (SRS) transmission, a semi-static code-point indication for codebook-based phase control, a dynamic code-point indication for codebook-based phase control, or dynamic per-panel phase values for chain-wise phase control, wherein one or more of the phase control for the quantity of NCR RF chains or the phase calibration for the NCR are based at least in part on the network node configuration.

Aspect 17: The method of any of Aspects 11-16, wherein facilitating the phase calibration further comprises: transmitting, to the network node, an indication of a minimum time duration for phase calibration; and receiving, from the network node, a configuration of one or more gap periods for phase calibration, wherein the one or more gap periods are associated with a downlink-uplink switching, an off-on transition, or a gain control, wherein one or more signals are not forwarded by the NCR during the one or more gap periods for phase calibration, wherein a phase calibration duration is triggered based at least in part on a phase coherency tracking or a request for a gap period for phase calibration from the NCR, wherein the phase calibration at the NCR is based at least in part on an internal calibration signal at the NCR.

Aspect 18: The method of any of Aspects 11-17, wherein facilitating the phase calibration further comprises: transmitting, to the network node, an indication of a minimum time duration for phase calibration; and receiving, from the network node, a configuration associated with a phase calibration reference signal, wherein the configuration indicates a timing for the phase calibration reference signal and additional resource and sequence information associated with the phase calibration reference signal; receiving, from the network node, a configuration of one or more gap periods for phase calibration, wherein one or more signals are not forwarded by the NCR during the one or more gap periods for phase calibration, wherein the phase calibration reference signal and a phase calibration duration are triggered based at least in part on a phase coherency tracking or a request for the phase calibration reference signal for phase calibration from the NCR; and receiving, from the network node, the phase calibration reference signal based at least in part on the phase calibration reference signal and the phase calibration duration being triggered, wherein the phase calibration at the NCR is based at least in part on measurements of the phase calibration reference signal.

Aspect 19: The method of any of Aspects 11-18, wherein facilitating the phase calibration further comprises: transmitting, to the network node, an indication of a minimum time duration for phase calibration; receiving, from the network node, a configuration associated with a phase calibration reference signal, wherein the configuration indicates a timing for the phase calibration reference signal and additional resource and sequence information associated with the phase calibration reference signal; and receiving, from the network node, a configuration of one or more gap periods for phase calibration, wherein one or more signals are not forwarded by the NCR during the one or more gap periods for phase calibration, wherein the phase calibration reference signal and a phase calibration duration are triggered based at least in part on a phase coherency tracking or a request for the phase calibration reference signal for phase calibration from the NCR, wherein the phase calibration reference signal is triggered to be received from a user equipment (UE), and wherein the phase calibration at the NCR is based at least in part on measurements of the phase calibration reference signal received from the UE.

Aspect 20: The method of any of Aspects 11-19, wherein facilitating the phase calibration further comprises: transmitting, to the network node, an indication of the quantity of NCR RF chains and a minimum time duration for phase calibration; receiving, from the network node, a configuration associated with a phase calibration reference signal, wherein the configuration indicates a timing for the phase calibration reference signal, a number of repetitions corresponding to the quantity of NCR RF chains, and additional resource and sequence information associated with the phase calibration reference signal; receiving, from the network node, a configuration of one or more gap periods for phase calibration, wherein one or more signals are not forwarded by the NCR during the one or more gap periods for phase calibration, wherein the phase calibration reference signal and a phase calibration duration are triggered based at least in part on a phase coherency tracking or a request for the phase calibration reference signal for phase calibration from the NCR; relaying, from the network node to a user equipment (UE), the phase calibration reference signal in accordance with an NCR RF chain on-off configuration, wherein each repetition of the phase calibration reference signal is communicated with one NCR RF chain of the quantity of NCR RF chains turned on and other NCR RF chains of the quantity of NCR RF chains turned off; relaying, from the UE to the network node, a report indicating phase change measurements associated with the phase calibration reference signal, wherein the report indicates the phase change measurements for different repetitions of the phase calibration reference signal; and receiving, from the network node and based at least in part on the report, an indication for phase values to be calibrated at the NCR, wherein the phase calibration is implemented at the NCR based at least in part on the indication received from the NCR.

Aspect 21: An apparatus for wireless communication at a device, comprising a processor; memory coupled with the processor; and instructions stored in the memory and executable by the processor to cause the apparatus to perform the method of one or more of Aspects 1-10.

Aspect 22: A device for wireless communication, comprising a memory and one or more processors coupled to the memory, the one or more processors configured to perform the method of one or more of Aspects 1-10.

Aspect 23: An apparatus for wireless communication, comprising at least one means for performing the method of one or more of Aspects 1-10.

Aspect 24: A non-transitory computer-readable medium storing code for wireless communication, the code comprising instructions executable by a processor to perform the method of one or more of Aspects 1-10.

Aspect 25: A non-transitory computer-readable medium storing a set of instructions for wireless communication, the set of instructions comprising one or more instructions that, when executed by one or more processors of a device, cause the device to perform the method of one or more of Aspects 1-10.

Aspect 26: An apparatus for wireless communication at a device, comprising a processor; memory coupled with the processor; and instructions stored in the memory and executable by the processor to cause the apparatus to perform the method of one or more of Aspects 11-20.

Aspect 27: A device for wireless communication, comprising a memory and one or more processors coupled to the memory, the one or more processors configured to perform the method of one or more of Aspects 11-20.

Aspect 28: An apparatus for wireless communication, comprising at least one means for performing the method of one or more of Aspects 11-20.

Aspect 29: A non-transitory computer-readable medium storing code for wireless communication, the code comprising instructions executable by a processor to perform the method of one or more of Aspects 11-20.

Aspect 30: A non-transitory computer-readable medium storing a set of instructions for wireless communication, the set of instructions comprising one or more instructions that, when executed by one or more processors of a device, cause the device to perform the method of one or more of Aspects 11-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a network node, comprising:
a processor;
memory coupled with the processor; and
instructions stored in the memory and executable by the processor to cause the apparatus to:
receive, from a network-controlled repeater (NCR), an NCR capability report that indicates a support for NCR forward beamforming and a quantity of NCR radio frequency (RF) chains; and
facilitate, based at least in part on the NCR capability report, one or more of: a phase control for the quantity of NCR RF chains to support a multiple-input multiple-output (MIMO) operation, or a phase calibration for the NCR.

2. The apparatus of claim 1, wherein the instructions stored in the memory and executable by the processor, to facilitate the phase control, further cause the apparatus to:
receive, from the NCR, an indication of a codebook size for a controllable phase; perform a synchronization signal block (SSB) sweeping based at least in part on the indication of the codebook size for the controllable phase, wherein a best controllable phase value in relation to a plurality of controllable phase values is based at least in part on the SSB sweeping;
transmit, to a user equipment (UE) and via the NCR, a channel state information reference signal (CSI-RS) based at least in part on the NCR setting the best controllable phase value; and
receive, from the UE and based at least in part on the CSI-RS, one or more of: a composite channel measurement, a rank indicator, a precoding matrix indicator, or a channel quality indicator.

3. The apparatus of claim 1, wherein the instructions stored in the memory and executable by the processor, to facilitate the phase control, further cause the apparatus to:
perform, with a user equipment (UE), an initial access based at least in part on a codebook-based synchronization signal block (SSB) sweeping;
transmit, to the UE and via the NCR, a plurality of time division multiplexed channel state information reference signal (CSI-RS) resources in accordance with an NCR RF chain on-off configuration, wherein each CSI-RS resource is transmitted with one NCR RF chain of the quantity of NCR RF chains turned on and other NCR RF chains of the quantity of NCR RF chains turned off; and
receive, from the UE and based at least in part on the plurality of time division multiplexed CSI-RS resources transmitted in accordance with the NCR RF chain on-off configuration, an indication of one or more of: best controllable phase values, a rank indicator (RI), a precoding matrix indicator (PMI), or a channel quality indicator (CQI), wherein one or more of the RI, the PMI, or the CQI are based at least in part on a composite channel measurement, and wherein the composite channel measurement is based at least in part on UE channel estimations during NCR RF chain on-off times.

4. The apparatus of claim 1, wherein the instructions stored in the memory and executable by the processor, to facilitate the phase control, further cause the apparatus to:
receive, from a user equipment (UE) and via the NCR, a plurality of time division multiplexed sounding reference signal (SRS) resources in accordance with an NCR RF chain on-off configuration, wherein each SRS resource is received with one NCR RF chain of the quantity of NCR RF chains turned on and other NCR RF chains of the quantity of NCR RF chains turned off; and
determine, based at least in part on the plurality of time division multiplexed SRS resources received in accordance with the NCR RF chain on-off configuration, best controllable phase values and a precoding matrix, wherein the precoding matrix is based at least in part on a composite channel measurement, and wherein the composite channel measurement is based at least in part on network node channel estimations during NCR RF chain on-off times.

5. The apparatus of claim 1, wherein the NCR capability report indicates whether an uplink-downlink reciprocity is supported, a codebook size, and a phase shifting alphabet.

6. The apparatus of claim 1, wherein the instructions stored in the memory and executable by the processor further cause the apparatus to:
transmit, to the NCR, a network node configuration that indicates one or more of: a semi-static per-chain on-off indication for a channel state information reference signal (CSI-RS) or sounding reference signal (SRS) transmission, a semi-static code-point indication for codebook-based phase control, a dynamic code-point indication for codebook-based phase control, or dynamic per-panel phase values for chain-wise phase control, wherein one or more of the phase control for the quantity of NCR RF chains or the phase calibration for the NCR are based at least in part on the network node configuration.

7. The apparatus of claim 1, wherein the instructions stored in the memory and executable by the processor, to facilitate the phase calibration, further cause the apparatus to:
receive, from the NCR, an indication of a minimum time duration for phase calibration;
transmit, to the NCR, a configuration of one or more gap periods for phase calibration, wherein the one or more gap periods are associated with a downlink-uplink switching, an off-on transition, or a gain control, and wherein one or more signals are not forwarded by the NCR during the one or more gap periods for phase calibration; and
trigger a phase calibration duration based at least in part on a phase coherency tracking or a request for a gap period for phase calibration received from the NCR, wherein the phase calibration at the NCR is based at least in part on an internal calibration signal at the NCR.

8. The apparatus of claim 1, wherein the instructions stored in the memory and executable by the processor, to facilitate the phase calibration, further cause the apparatus to:
receive, from the NCR, an indication of a minimum time duration for phase calibration;
transmit, to the NCR, a configuration associated with a phase calibration reference signal, wherein the configuration indicates a timing for the phase calibration reference signal and additional resource and sequence information associated with the phase calibration reference signal;
transmit, to the NCR, a configuration of one or more gap periods for phase calibration, wherein one or more signals are not forwarded by the NCR during the one or more gap periods for phase calibration;
trigger the phase calibration reference signal and a phase calibration duration based at least in part on a phase coherency tracking or a request for the phase calibration reference signal for phase calibration received from the NCR; and
transmit, to the NCR, the phase calibration reference signal based at least in part on the trigger, wherein the phase calibration at the NCR is based at least in part on measurements of the phase calibration reference signal.

9. The apparatus of claim 1, wherein the instructions stored in the memory and executable by the processor, to facilitate the phase calibration, further cause the apparatus to:
receive, from the NCR, an indication of a minimum time duration for phase calibration;
transmit, to the NCR, a configuration associated with a phase calibration reference signal, wherein the configuration indicates a timing for the phase calibration reference signal and additional resource and sequence information associated with the phase calibration reference signal;
transmit, to the NCR, a configuration of one or more gap periods for phase calibration, wherein one or more signals are not forwarded by the NCR during the one or more gap periods for phase calibration; and
trigger the phase calibration reference signal and a phase calibration duration based at least in part on a phase coherency tracking or a request for the phase calibration reference signal for phase calibration received from the NCR, wherein the phase calibration reference signal is triggered to be received from a user equipment (UE), and wherein the phase calibration at the NCR is based at least in part on measurements of the phase calibration reference signal received from the UE.

10. The apparatus of claim 1, wherein the instructions stored in the memory and executable by the processor, to facilitate the phase calibration, further cause the apparatus to:
receive, from the NCR, an indication of the quantity of NCR RF chains and a minimum time duration for phase calibration;
transmit, to the NCR, a configuration associated with a phase calibration reference signal, wherein the configuration indicates a timing for the phase calibration reference signal, a number of repetitions corresponding to the quantity of NCR RF chains, and additional resource and sequence information associated with the phase calibration reference signal;
transmit, to the NCR, a configuration of one or more gap periods for phase calibration, wherein one or more signals are not forwarded by the NCR during the one or more gap periods for phase calibration;
trigger the phase calibration reference signal and a phase calibration duration based at least in part on a phase coherency tracking or a request for the phase calibration reference signal for phase calibration received from the NCR;
transmit, to a user equipment (UE) and via the NCR, the phase calibration reference signal in accordance with an NCR RF chain on-off configuration, wherein each repetition of the phase calibration reference signal is transmitted with one NCR RF chain of the quantity of NCR RF chains turned on and other NCR RF chains of the quantity of NCR RF chains turned off,
receive, from the UE, a report indicating phase change measurements associated with the phase calibration reference signal, wherein the report indicates the phase change measurements for different repetitions of the phase calibration reference signal; and
transmit, to the NCR and based at least in part on the report, an indication for phase values to be calibrated at the NCR, wherein the phase calibration is implemented at the NCR based at least in part on the indication received from the NCR.

11. An apparatus for wireless communication at a network-controlled repeater (NCR), comprising:
a processor;
memory coupled with the processor; and
instructions stored in the memory and executable by the processor to cause the apparatus to:
transmit, to a network node, an NCR capability report that indicates a support for NCR forward beamforming and a quantity of NCR radio frequency (RF) chains; and
facilitate, based at least in part on the NCR capability report, one or more of: a phase control for the quantity of NCR RF chains to support a multiple-input multiple-output (MIMO) operation, or a phase calibration for the NCR.

12. The apparatus of claim 11, wherein the instructions stored in the memory and executable by the processor, to facilitate the phase control, further cause the apparatus to:
transmit, to the network node, an indication of a codebook size for a controllable phase, wherein a synchronization signal block (SSB) sweeping is based at least in part on the indication of the codebook size for the controllable phase, and wherein a best controllable phase value in relation to a plurality of controllable phase values is based at least in part on the SSB sweeping;
relay, from the network node to a user equipment (UE), a channel state information reference signal (CSI-RS) based at least in part on setting the best controllable phase value; and
relay, from the UE to the network node, one or more of: a composite channel measurement, a rank indicator, a precoding matrix indicator, or a channel quality indicator.

13. The apparatus of claim 11, wherein the instructions stored in the memory and executable by the processor, to facilitate the phase control, further cause the apparatus to:
relay, from the network node to a user equipment (UE), a plurality of time division multiplexed channel state information reference signal (CSI-RS) resources in accordance with an NCR RF chain on-off configuration, wherein each CSI-RS resource is communicated with one NCR RF chain of the quantity of NCR RF chains turned on and other NCR RF chains of the quantity of NCR RF chains turned off, and
relay, from the UE to the network node and based at least in part on the plurality of time division multiplexed CSI-RS resources transmitted in accordance with the NCR RF chain on-off configuration, an indication of one or more of: best controllable phase values, a rank indicator (RI), a precoding matrix indicator (PMI), or a channel quality indicator (CQI), wherein one or more of the RI, the PMI, or the CQI are based at least in part on a composite channel measurement, and wherein the composite channel measurement is based at least in part on UE channel estimations during NCR RF chain on-off times.

14. The apparatus of claim 11, wherein the instructions stored in the memory and executable by the processor, to facilitate the phase control, further cause the apparatus to: relay, from a user equipment (UE) to the network node, a plurality of time division multiplexed sounding reference signal (SRS) resources in accordance with an NCR RF chain on-off configuration, wherein each SRS resource is communicated with one NCR RF chain of the quantity of NCR RF chains turned on and other NCR RF chains of the quantity of NCR RF chains turned off, wherein best controllable phase values and a precoding matrix are based at least in part on the plurality of time division multiplexed SRS resources, wherein the precoding matrix is based at least in part on a composite channel measurement, and wherein the composite channel measurement is based at least in part on network node channel estimations during NCR RF chain on-off times.

15. The apparatus of claim 11, wherein the NCR capability report indicates whether an uplink-downlink reciprocity is supported, a codebook size, and a phase shifting alphabet.

16. The apparatus of claim 11, wherein the instructions stored in the memory and executable by the processor further cause the apparatus to:
receive, from the network node, a network node configuration that indicates one or more of: a semi-static per-chain on-off indication for a channel state information reference signal (CSI-RS) or sounding reference signal (SRS) transmission, a semi-static code-point indication for codebook-based phase control, a dynamic code-point indication for codebook-based phase control, or dynamic per-panel phase values for chain-wise phase control, wherein one or more of the phase control for the quantity of NCR RF chains or the phase calibration for the NCR are based at least in part on the network node configuration.

17. The apparatus of claim 11, wherein the instructions stored in the memory and executable by the processor, to facilitate the phase calibration, further cause the apparatus to:
transmit, to the network node, an indication of a minimum time duration for phase calibration; and
receive, from the network node, a configuration of one or more gap periods for phase calibration, wherein the one or more gap periods are associated with a downlink-uplink switching, an off-on transition, or a gain control, wherein one or more signals are not forwarded by the NCR during the one or more gap periods for phase calibration, wherein a phase calibration duration is triggered based at least in part on a phase coherency tracking or a request for a gap period for phase calibration from the NCR, wherein the phase calibration at the NCR is based at least in part on an internal calibration signal at the NCR.

18. The apparatus of claim 11, wherein the instructions stored in the memory and executable by the processor, to facilitate the phase calibration, further cause the apparatus to:
transmit, to the network node, an indication of a minimum time duration for phase calibration; and
receive, from the network node, a configuration associated with a phase calibration reference signal, wherein the configuration indicates a timing for the phase calibration reference signal and additional resource and sequence information associated with the phase calibration reference signal;
receive, from the network node, a configuration of one or more gap periods for phase calibration, wherein one or more signals are not forwarded by the NCR during the one or more gap periods for phase calibration, wherein the phase calibration reference signal and a phase calibration duration are triggered based at least in part on a phase coherency tracking or a request for the phase calibration reference signal for phase calibration from the NCR; and
receive, from the network node, the phase calibration reference signal based at least in part on the phase calibration reference signal and the phase calibration duration being triggered, wherein the phase calibration at the NCR is based at least in part on measurements of the phase calibration reference signal.

19. The apparatus of claim 11, wherein the instructions stored in the memory and executable by the processor, to facilitate the phase calibration, further cause the apparatus to:
transmit, to the network node, an indication of a minimum time duration for phase calibration;
receive, from the network node, a configuration associated with a phase calibration reference signal, wherein the configuration indicates a timing for the phase calibration reference signal and additional resource and sequence information associated with the phase calibration reference signal; and
receive, from the network node, a configuration of one or more gap periods for phase calibration, wherein one or more signals are not forwarded by the NCR during the one or more gap periods for phase calibration, wherein the phase calibration reference signal and a phase calibration duration are triggered based at least in part on a phase coherency tracking or a request for the phase calibration reference signal for phase calibration from the NCR, wherein the phase calibration reference signal is triggered to be received from a user equipment (UE), and wherein the phase calibration at the NCR is based at least in part on measurements of the phase calibration reference signal received from the UE.

20. (canceled)

21. A method of wireless communication performed by a network node, comprising:
receiving, from a network-controlled repeater (NCR), an NCR capability report that indicates a support for NCR forward beamforming and a quantity of NCR radio frequency (RF) chains; and
facilitating, based at least in part on the NCR capability report, one or more of: a phase control for the quantity of NCR RF chains to support a multiple-input multiple-output (MIMO) operation, or a phase calibration for the NCR.

22-30. (canceled)
